(19) United States
(12) Patent Application Publication
(10) Pub. No.: US 2026/0152413 A1
(43) Pub. Date: Jun. 4, 2026

(54) BATTERY MATERIALS

(71) Applicant: UNIVERSITY COURT OF THE UNIVERSITY OF ST ANDREWS, St Andrews (GB)

(72) Inventors: Yingling Liao, St Andrews (GB); Anthony Robert Armstrong, St Andrews (GB); Chenchen Wang, St Andrews (GB)

(73) Assignee: UNIVERSITY COURT OF THE UNIVERSITY OF ST ANDREWS, St Andrews (GB)

(21) Appl. No.: 19/122,258

(22) PCT Filed: Oct. 18, 2023
(86) PCT No.: PCT/EP2023/079014

§ 371 Date: Apr. 18, 2025

(30) Foreign Application Priority Data
Oct. 18, 2022 (GB) 2215416.5

(51) Int. Cl. C01G 53/51; H01M 4/04; H01M 4/505; H01M 4/525; H01M 10/054

(52) U.S. Cl. CPC C01G 53/51; H01M 4/0471; H01M 4/505; H01M 4/525; H01M 10/054; C01P 2002/72; C01P 2002/76; C01P 2004/82; C01P 2006/40

(57) ABSTRACT

The present invention relates to mixed phase layered sodium metal oxide materials, which have been found to have properties that are advantageous for use of the materials in sodium-ion batteries. The present invention also relates to a method of forming such materials via a sol-gel route. Electrodes comprising the layered sodium metal oxide materials as well as energy storage devices comprising the layered sodium metal oxide materials are also considered.

### TECHNICAL FIELD

The present invention relates to mixed phase layered sodium metal oxide materials, which have been found to have properties that are advantageous for use of the materials in sodium-ion batteries. The present invention also relates to a method of forming such materials via a sol-gel route. Electrodes comprising the layered sodium metal oxide materials as well as energy storage devices comprising the layered sodium metal oxide materials are also considered.

### BACKGROUND

Sodium-ion batteries (SIBs) show great promise as a low cost, sustainable and safe complement to Li-ion batteries (LIBs) for energy storage applications such as grid storage, data centres, and low speed electric vehicles. Li-ion batteries have shown great utility in high energy density applications such as portable electronics and electric cars, but suffer from multiple disadvantages related to safety and cost of the raw materials.

For example, Li-ion batteries must be transported in a partially charged state, due to concerns over the dissolution of the Cu current collector at 0 V, which adds significant costs and safety issues. In contrast, Na-ion batteries use Al current collectors which do not react with Na even at 0 V, allowing them to be transported in the fully discharged state and thus removing safety concerns. Additionally, while LIBs have had several high profile issues related to the flammability of the electrolytes, SIB liquid electrolytes have been reported to be essentially non-flammable under testing, further enhancing the safety profile of SIBs.

Layered sodium metal oxides (NaₓMO₂) offer significant advantages over other positive electrode materials such as high capacity, high voltage and high tap densities, all of which make them ideal for high energy density batteries. Layered sodium metal oxides crystalize into two common phase structures, O3 and P2, classified using the nomenclature of Delmas et al (DOI: 10.1016/0378-4363(80)90214-4). All layered sodium metal oxides consist of alternating Na layers and transition metal layers, each separated by oxygen layers. O-type phases contain Na in octahedral sites, while P-type Na resides in prismatic sites. The numbers in the labels correspond to the number of layers required to complete a unit cell. Therefore, P2-type materials contain Na in prismatic sites, and contain 2 repeat layers in a unit cell, as a result of the ABBA-type stacking of the oxygen atoms. O3 phases have Na in octahedral sites, and require 3 repeat layers to form the unit cell, due to the ABCABC oxygen arrangement.

Typically, O3-type materials show higher initial charge capacities due to higher Na contents (typically 0.8-1 occupancy). However, the diffusion of sodium ions through the material occurs via intermediate edge sharing tetrahedral sites, which impose a high energy barrier. Thus, whilst O3-type materials may be formed with higher Na content, allowing high capacity, they often show poor rate and cycling performance.

In contrast to O3-type materials, the sodium ions in P2-type materials are able to diffuse directly between face-sharing trigonal prismatic sites, thus imposing a lower energy barrier to sodium diffusion than analogous O3-type materials. Whilst P2-type materials exhibit superior rate capabilities and cycling stabilites, the low Na contents of P2-type materials (typically around 0.67) hinders the use of this class of material in cells comprising non-sodiated negative electrodes (such as commonly used hard carbons), where the positive electrode is the only Na source, resulting in low energy densities.

Layered sodium metal oxides may also crystallise into P3 phases. P3-type materials contain Na in prismatic sites, and contain 3 repeat layers in a unit cell, as a result of the ABBCCA-type stacking of the oxygen atoms. As with P2-type materials, the sodium ions in P3-type materials are able to diffuse directly between face-sharing trigonal prismatic sites, thereby imposing a lower energy barrier to sodium diffusion than analogous O3-type materials. P3-type materials may be formed at lower temperature whilst retaining some of the stability and rate performance advantages of P2-type materials.

A recent strategy in the development of sodium metal oxide materials for use in sodium-ion batteries is to combine multiple phases in one material in order to benefit from the advantages of each phase. This is commonly achieved by incorporating multiple transition metals into the sodium metal oxide material.

Bi-phasic P2/P3-type sodium metal oxides comprising various metals, including metals considered to be toxic or of limited supply, are known in the art. Such materials comprising: lithium, magnesium, nickel and manganese have been synthesised by Y.-N. Zhou et al., reported in Nano Energy, 2019, 55, 143-150; cobalt, copper, iron, nickel and manganese have been synthesised by M. M. Rahman et al., reported in ACS Materials Lett., 2019, 1, 573-581; cobalt, nickel and manganese have been synthesised by P. Hou et al., reported in Nanoscale, 2018, 10, 6671 and also by L. G. Chagas et al., reported in J. Mater. Chem. A, 2014, 2, 20263-20270; nickel, manganese and tin have been synthesised by J. Li et al, reported in Journal of Power Sources, 2020, 449, 227554; aluminium, cobalt, nickel and manganese have been synthesised by D. D. Lecce et al., in J. Phys. Chem. C, 2018, 122, 23925-23933; lithium, nickel and manganese have been synthesised by E. Lee et al., reported in Adv. Energy Mater., 2014, 4, 1400458; lithium, copper, zinc and manganese are reported in WO 2020/232572 (Liaoning Starry Sky Sodium Battery Co. Ltd.); magnesium, nickel and manganese have been synthesised by Shilin Su et al., in Journal of Solid State Chemistry, 2022, 308, 122916 and are also reported in CN 113889613 A (Univ. Central South).

Triphasic sodium metal oxides comprising nickel, cobalt, manganese and optionally magnesium have been synthesised by H.-Y. Hu et al., reported in Adv. Energy Mater., 2022, 12, 2201511. Electrodes comprising doped nickelate-containing compositions have been described. The compositions comprise an O3-type component, which is a sodium metal oxide comprising nickel, manganese, magnesium and titanium, a P2-type component, which is a sodium metal oxide comprising nickel, manganese and optionally magnesium and/or titanium, and a P3-type component, which is a sodium metal oxide comprising nickel, manganese and titanium.

In addition, tri-phasic and bi-phasic sodium metal oxides comprising nickel and manganese have been synthesised by R. Li et al., reported in Adv. Funct. Mater., 2022, 32, 2205661 and comprise P2-type, P3-type and/or O3-type phases. The tri-phasic material in particular is reported to exhibit high cycling stability and high rate performance. Bi-phasic sodium metal oxides comprising manganese and nickel have also been synthesised by D. Wang et al., reported in ChemElectroChem., 2019, 6, 5155-5161 and comprise P2-type and P3-type phases.

Furthermore, sodium metal oxides of a P2-type or a P3-type structure comprising sodium in relatively low levels, as well as nickel, manganese and optionally magnesium and/or titanum are described in WO 2015/177544 (Faradion Limited).

There is a need in the art for alternative layered sodium metal oxides comprising multiple phases and avoiding (e.g. reducing or eliminating) the use of metals considered of limited supply. The present invention addresses this need.

### SUMMARY OF THE INVENTION

The present invention is based on the unexpected finding that specific layered sodium metal oxide materials comprising manganese, nickel, an element selected from iron, copper, zinc and aluminium and optionally one or more elements selected from iron, copper, zinc, magnesium, titanium and aluminium, and having at least a P2-type and a P3-type phase are effective materials for use in sodium-ion batteries. The materials have high capacity, and so are able to store energy effectively, whilst also exhibiting a long cycle life and fast charge/discharge rate. In addition, the materials are cobalt-free.

By cobalt-free, it is to be understood that cobalt is not intentionally included, although it will be appreciated that there may be unavoidable impurities, which may include cobalt. Whilst O3 structures may be formed with high Na content, allowing a high capacity, they show poor rate and cycling performance. By using P3 rather than O3 structure, it is possible to reduce the synthesis temperature and retain good performance. In addition, it has been found that the P3 phase has a stability window which occurs at higher Na content than previously believed. As such, the materials of the present disclosure are preferably free of O3 structures.

Furthermore, the present invention provides materials with tuneable P2:P3 ratios, from pure phase. By providing a composition that allows a tunable P2:P3 ratio, the present invention allows for the fundamental relationship between the crystal structure and electrochemical performance to be exploited. Changing the P2:P3 ratio allows for the tuning of performance parameters such as the voltage window, energy density, cycling stability and charge/discharge rate. This provides options for the production and use of low-cost positive electrode materials by allowing the same chemistry to be targeted at different applications (e.g. high energy or high power) by tuning the P2:P3 ratio.

Accordingly, viewed from a first aspect, the invention provides a layered sodium metal oxide material having at least a P2-type phase and a P3-type phase, the material having the general formula:

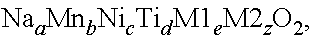

wherein:
M1 is an element selected from iron, copper, zinc and aluminium; M2 consists of one or more elements different to M1 and selected from iron, copper, zinc, magnesium and aluminium; and
   wherein:

$$0.5 < a \leq 1 ;$$

$$0 \leq b \leq 0.7 ;$$

$$0 < c \leq 0.5 ;$$

$$0 \leq d \leq 0.4 ;$$

$$0 < e \leq 0 \text{.25} ;$$

$$0 < e + z \leq 0.25 ; and$$

$$b + c + d + e + z \leq 1.$$

The materials of the invention find use in electrodes, e.g. within batteries. Therefore, viewed from a second aspect, the invention provides an electrode comprising the material of the first aspect.

Viewed from a third aspect, the invention provides an energy storage device (such as a sodium-ion battery) comprising the material of the first aspect or the electrode of the second aspect.

Viewed from a fourth aspect, the invention provides a method of forming material as defined in the first aspect, the method comprising:
(a) providing a metal salt solution, the metal salts including salts of Na, Mn, Ni, and M1;
(b1) optionally mixing a Ti source with the metal salt solution;
(b2) optionally mixing a salt of M2 with the metal salt solution;
(c) mixing a gelator with the metal salt solution to form a sol-gel solution;
(d) increasing the pH of the sol-gel solution;
(e) heating the sol-gel solution to form a gel; and
(f) subjecting the gel to calcination to obtain the material;
   Wherein M1 is an element selected from iron, copper, zinc and aluminium; and M2 consists of one or more elements different to M1 and selected from iron, copper, zinc, magnesium and aluminium.

Further aspects and embodiments of the present invention will become apparent from the detailed discussion of the invention that follows below.

### BRIEF DESCRIPTION OF THE FIGURES

FIG. 1 is a powder X-ray diffractogram using a MoKα₁ source of X-rays showing the presence of P2 and P3 phases in Na_{0.75}Mn_{0.68}Ni_{0.25}Mg_{0.07}O₂ prepared by calcining at 840° C. for 3 hours and 500° C. for 5 hours (black trace) and 860° C. for 3 hours and 500° C. for 5 hours (grey trace).

FIG. 2a compares discharge capacities for Na_{0.75}Mn_{0.68}Ni_{0.25}Mg_{0.07}O₂ in pure P2-type phase, pure P3-type phase or having both a P2-type phase and a P3-type across 100 cycles at 25 mA g⁻¹.

FIG. 2b compares capacity densities for Na_{0.75}Mn_{0.68}Ni_{0.25}Mg_{0.07}O₂ in pure P2-type phase, pure P3-type phase or having both a P2-type phase and a P3-type across a maximum of 50 cycles at 25, 100, 200 and 500 mA g⁻¹

FIG. 2c shows the charge/discharge profiles of Na_{0.75}Mn_{0.68}Ni_{0.25}Mg_{0.07}O₂ cycled between 2.2-4.3 V at 25 mA g⁻¹.

FIG. 3 is a powder X-ray diffractogram using a CuKα₁ source of X-rays showing the presence of P2 and P3 phases in Na_{0.75}Mn_{0.68}Ni_{0.25}Zn_{0.07}O₂ prepared by calcining at 840° C. for 3 hours and 500° C. for 5 hours (black trace) and 860° C. for 3 hours and 500° C. for 5 hours (grey trace).

FIG. 4a shows the discharge capacity of Na_{0.75}Mn_{0.68}Ni_{0.25}Zn_{0.07}O₂ across up to 25 cycles at 25 mA g⁻¹.

FIG. 4b shows the charge/discharge profiles of Na_{0.75}Mn_{0.68}Ni_{0.25}Zn_{0.07}O₂ calcined at 840° C., cycled between 2.2-4.3 V at 25 mA g⁻¹.

FIG. 5a shows the discharge capacity of Na_{0.75}Mn_{0.68}Ni_{0.25}Zn_{0.07}O₂ across up to 15 cycles at 25 mA g⁻¹.

FIG. 5b shows the charge/discharge profiles of Na_{0.75}Mn_{0.68}Ni_{0.25}Zn_{0.07}O₂ calcined at 860° C., cycled between 2.2-4.3 V at 25 mA g⁻¹.

FIG. 6a is a powder X-ray diffractogram using a MoKα₁ source of X-rays showing the presence of P2 and P3 phases in Na_{0.75}Mn_{0.68}Ni_{0.25}Cu_{0.07}O₂ prepared by calcining at the different temperatures shown for the times shown, and 500° C. for 5 hours.

FIG. 6b shows the charge/discharge profiles of Na_{0.75}Mn_{0.68}Ni_{0.25}Cu_{0.07}O₂ calcined at the different temperatures/times shown, cycled between 2.2-4.3 V at 25 mA g⁻¹.

FIG. 6c shows the discharge capacity of Na_{0.75}Mn_{0.68}Ni_{0.25}Cu_{0.07}O₂ calcined at the different temperatures/times shown across up to 100 cycles at 25 mA g⁻¹.

FIG. 7a is a powder X-ray diffractogram using a MoKα₁ source of X-rays showing the presence of P2 and P3 phases in Na_{0.75}Mn_{0.63}Ni_{0.25}Cu_{0.07}Ti_{0.05}O₂ prepared by calcining at the different temperatures shown for the times shown, and 500° C. for 5 hours.

FIG. 7b shows the charge/discharge profiles of Na_{0.75}Mn_{0.63}Ni_{0.25}Cu_{0.07}Ti_{0.05}O₂ calcined at the different temperatures shown, cycled between 2.2-4.3 V at 25 mA g⁻¹.

FIG. 7c shows the discharge capacity of Na_{0.75}Mn_{0.63}Ni_{0.25}Cu_{0.07}Ti_{0.05}O₂ calcined at the different temperatures/times shown across up to 100 cycles at 25 mA g⁻¹.

FIG. 7d compares capacity densities for Na_{0.75}Mn_{0.63}Ni_{0.25}Cu_{0.07}Ti_{0.05}O₂ in pure P2-type phase, pure P3-type phase or having both a P2-type phase and a P3-type across a maximum of 50 cycles at 25, 100, 200, 300, 500, 800 and 1000 mA g⁻¹.

FIG. 8a is a powder X-ray diffractogram using a MoKα₁ source of X-rays showing the presence of P2 and P3 phases in Na_{0.75}Mn_{0.58}Ni_{0.25}Cu_{0.07}Ti_{0.1}O₂ prepared by calcining at the different temperatures shown for the times shown, and 500° C. for 5 hours.

FIG. 8b shows the charge/discharge profiles of Na_{0.75}Mn_{0.58}Ni_{0.25}Cu_{0.07}Ti_{0.1}O₂ calcined at the different temperatures shown, cycled between 2.2-4.3 V at 25 mA g⁻¹.

FIG. 8c shows the discharge capacity of Na_{0.75}Mn_{0.58}Ni_{0.25}Cu_{0.07}Ti_{0.1}O₂ calcined at the different temperatures/times shown across up to 100 cycles at 25 mA g⁻¹.

FIG. 9a is a powder X-ray diffractogram using a MoKα₁ source of X-rays showing the presence of P2 and P3 phases in Na_{0.75}Mn_{0.57}Ni_{0.25}Cu_{0.07}Fe_{0.1}O₂ prepared by calcining at the temperature shown for the time shown, and 500° C. for 5 hours.

FIG. 9b shows the charge/discharge profiles of Na_{0.75}Mn_{0.57}Ni_{0.25}Cu_{0.07}Fe_{0.1}O₂, cycled between 2.2-4.3 V at 25 mA g⁻¹.

FIG. 9c shows the discharge capacity of Na_{0.75}Mn_{0.57}Ni_{0.25}Cu_{0.07}Fe_{0.1}O₂ across up to 100 cycles at 25 mA g⁻¹.

FIG. 10a is a powder X-ray diffractogram using a MoKα₁ source of X-rays showing the presence of P2 and P3 phases in Na_{0.75}Mn_{0.52}Ni_{0.25}Cu_{0.07}Fe_{0.1}Ti_{0.05}O₂ prepared by calcining at the different temperatures shown for the times shown, and 500° C. for 5 hours.

FIG. 10b shows the charge/discharge profiles of Na_{0.75}Mn_{0.52}Ni_{0.25}Cu_{0.07}Fe_{0.1}Ti_{0.05}O₂ calcined at the different temperatures/times shown, cycled between 2.2-4.3 V at 25 mA g⁻¹.

FIG. 10c shows the discharge capacity of Na_{0.75}Mn_{0.52}Ni_{0.25}Cu_{0.07}Fe_{0.1}Ti_{0.05}O₂ calcined at the different temperatures/times shown across up to 100 cycles at 25 mA g⁻¹.

FIG. 11a is a powder X-ray diffractogram using a MoKα₁ source of X-rays showing the presence of P2 and P3 phases in Na_{0.75}Mn_{0.52}Ni_{0.25}Cu_{0.07}Fe_{0.1}Ti_{0.05}O₂ and Na_{0.85}Mn_{0.52}Ni_{0.25}Cu_{0.07}Fe_{0.1}Ti_{0.05}O₂ prepared by calcining at the different temperatures shown for the times shown, and 500° C. for 5 hours.

FIG. 11b shows the charge/discharge profiles of Na_{0.75}Mn_{0.52}Ni_{0.25}Cu_{0.07}Fe_{0.1}Ti_{0.05}O₂ and Na_{0.85}Mn_{0.52}Ni_{0.25}Cu_{0.07}Fe_{0.1}Ti_{0.05}O₂ calcined at the different temperatures/times shown, cycled between 2.2-4.3 V at 25 mA g⁻¹.

FIG. 11c shows the discharge capacity of Na_{0.75}Mn_{0.52}Ni_{0.25}Cu_{0.07}Fe_{0.1}Ti_{0.05}O₂ calcined at the different temperatures/times shown across up to 100 cycles at 25 mA g⁻¹.

FIG. 11d compares capacity densities for Na_{0.75}Mn_{0.52}Ni_{0.25}Cu_{0.07}Fe_{0.1}Ti_{0.05}O₂ calcined at the different temperatures/times shown across a maximum of 37 cycles at 25, 100, 200, 300, 500, 800 and 1000 mA g⁻¹.

FIG. 12a is a powder X-ray diffractogram using a MoKα₁ source of X-rays showing the presence of P2 and P3 phases in both non-water soaked and water-soaked Na_{0.75}Mn_{0.63}Ni_{0.25}Cu_{0.07}Ti_{0.05}O₂ and Na_{0.75}Mn_{0.63}Ni_{0.25}Cu_{0.07}Ti_{0.1}O₂.

FIG. 12b shows the discharge capacity of electrodes with or without water-soaked Na_{0.75}Mn_{0.63}Ni_{0.25}Cu_{0.07}Ti_{0.05}O₂ with either a PVdF or a CMC/SBR binder across up to 100 cycles at 25 mA g⁻¹.

FIG. 12c compares capacity densities for electrodes with or without water-soaked Na_{0.75}Mn_{0.63}Ni_{0.25}Cu_{0.07}Ti_{0.05}O₂ with either a PVdF or a CMC/SBR binder across a maximum of 50 cycles at 25, 100, 200, 300, 500, 800 and 1000 mA g⁻¹.

FIG. 12d shows the discharge capacity of electrodes with or without water-soaked Na_{0.75}Mn_{0.63}Ni_{0.25}Cu_{0.07}Ti_{0.1}O₂ with either a PVdF or a CMC/SBR binder across up to 100 cycles at 25 mA g⁻¹.

FIG. 13a is a powder X-ray diffractogram using a MoKα₁ source of X-rays showing the presence of P2 and P3 phases in Na_{0.75}Mn_{0.65}Ni_{0.25}Mg_{0.05}Zn_{0.05}O₂.

FIG. 13b shows the discharge capacity and coulombic efficiency of Na_{0.75}Mn_{0.65}Ni_{0.25}Mg_{0.05}Zn_{0.05}O₂ across up to 100 cycles at 25 mA g⁻¹.

FIG. 13c compares capacity densities for Na_{0.75}Mn_{0.65}Ni_{0.25}Mg_{0.05}Zn_{0.05}O₂ across a maximum of 26 cycles at 25, 100, 200, 500 and 25 mA g⁻¹, (the dots being provided in five sets from left to right corresponding to 25, 100, 200, 500, and 25 mA g⁻¹).

FIG. 13d shows the charge/discharge profiles of Na_{0.75}Mn_{0.65}Ni_{0.25}Mg_{0.05}Zn_{0.05}O₂, cycled between 2.2-4.3 V at 25 mA g⁻¹.

FIG. 14a is a powder X-ray diffractogram using a MoKα₁ source of X-rays showing the presence of P2 and P3 phases in Na_{0.75}Mn_{0.58}Ni_{0.27}Ti_{0.1}Zn_{0.07}O₂.

FIG. 14b shows the discharge capacity of Na_{0.75}Mn_{0.58}Ni_{0.27}Ti_{0.1}Zn_{0.07}O₂ across up to 100 cycles at 25 mA g⁻¹.

FIG. 14c shows the charge/discharge profiles of Na_{0.75}Mn_{0.58}Ni_{0.27}Ti_{0.1}Zn_{0.07}O₂, cycled between 2.2-4.3 V at 25 mA g⁻¹.

FIG. 15a is a powder X-ray diffractogram using a MoKα₁ source of X-rays showing the presence of P2 and P3 phases in Na_{0.75}Mn_{0.65}Ni_{0.25}Fe_{0.05}Zn_{0.07}O₂.

FIG. 15b shows the discharge capacity of Na_{0.75}Mn_{0.68}Ni_{0.25}Fe_{0.05}Zn_{0.07}O₂ across up to 100 cycles at 25 mA g⁻¹.

FIG. 15c shows the charge/discharge profiles of Na_{0.75}Mn_{0.65}Ni_{0.25}Fe_{0.05}Zn_{0.07}O₂, cycled between 2.2-4.3 V at 25 mA g⁻¹.

FIG. 16a is a powder X-ray diffractogram using a MoKα₁ source of X-rays showing the presence of P2 and P3 phases in Na_{0.75}Mn_{0.65}Ni_{0.25}Fe_{0.1}O₂.

FIG. 16b shows the discharge capacity of Na_{0.75}Mn_{0.65}Ni_{0.25}Fe_{0.1}O₂ across up to 100 cycles at 25 mA g⁻¹.

FIG. 16c shows the charge/discharge profiles of Na_{0.75}Mn_{0.65}Ni_{0.25}Fe_{0.1}O₂, cycled between 2.2-4.3 V at 25 mA g⁻¹.

### DETAILED DESCRIPTION OF THE INVENTION

As described above, the inventors have found that specific layered sodium metal oxide materials comprising manganese, nickel, an element selected from iron, copper, zinc, titanium and aluminium and optionally one or more elements selected from iron, copper, zinc, magnesium and aluminium, and having at least a P2-type and a P3-type phase are effective materials for use in sodium-ion batteries.

The material of the invention has the general formula:

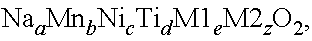

wherein:
M1 is an element selected from iron, copper, zinc, and aluminium; M2 consists of one or more elements different to M1 and selected from iron, copper, zinc, magnesium and aluminium; and
   wherein:

$$0.5 < a \leq 1 ;$$

$$0 \leq b \leq 0.7 ;$$

$$0 < c \leq 0.5 ;$$

$$0 \leq d \leq 0.4 ;$$

$$0 < e \leq 0 \text{.25} ;$$

$$0 < e + z \leq 0.25 ; and$$

$$b + c + d + e + z \leq 1.$$

Alternatively, the material of the invention may have the general formula:

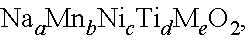

wherein:
M comprises one or more elements selected from the group consisting of magnesium, zinc, aluminium and copper; and
   wherein:

$$0.5 < a \leq 1 ;$$

$$0 \leq b \leq 0.7 ;$$

$$0 < c \leq 0.5 ;$$

$$0 \leq d \leq 0.4 ;$$

$$0 < e \leq 0.25 ; and$$

$$b + c + d + e \leq 1.$$

For example, M may consist of one element selected from zinc, aluminium and copper and optionally one or more other, different, elements selected from magnesium, zinc, aluminium and copper.

For the avoidance of doubt, the material of the invention is an intergrowth composite material, i.e. the components of the material are in intimate contact at the atomic level and form intergrowths with each other with both phases present within single particles.

In some embodiments, a is at least 0.6, 0.62, 0.64, 0.66, 0.68, 0.7, 0.71 or 0.72. In some embodiments, a is no more than 0.95, 0.9, 0.85, or 0.8. In some embodiments, 0.6≤a≤1, 0.6≤a≤09, 0.7≤a≤1, 0.7≤a≤0.9, 0.7≤a≤0.85, or 0.7≤a≤0.8. In some embodiments, 0.6≤a≤1, 0.7≤a≤1, 0.7≤a≤0.9, 0.7≤a≤0.85, or 0.7≤a≤0.8. For example, a may be 0.70, 0.71, 0.72, 0.73, 0.74, 0.75, 0.76, 0.77, 0.78, 0.79, or 0.80.

In some embodiments, b is at least 0.15, 0.2, 0.25, 0.3 or 0.35. In some embodiments, b is no more than 0.7, 0.69 or 0.68. In some embodiments, 0.15≤b≤0.7, 0.2≤b≤0.7, 0.25≤b≤0.7, 0.3≤b≤0.7, 0.35≤b≤0.7, 0.4≤b≤0.7, 0.45≤b≤0.7, 0.5≤b≤0.7, 0.55≤b≤0.7, or 0.6≤b≤0.7. For example, b may be 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69 or 0.70.

In some embodiments, c is at least 0.15, 0.2, or 0.25. In some embodiments, c is no more than 0.45, 0.4, or 0.35. In some embodiments, 0.15≤c≤0.5, 0.2≤c≤0.5, 0.2≤c≤0.4, 0.25≤c≤0.4, or 0.25≤c≤0.35. For example, c may be 0.20, 0.2, 0.22, 0.23, 0.24, 0.25, 0.26, 0.27, 0.28, 0.29, 0.30, 0.31, 0.32, 0.33, 0.34, or 0.35.

In further embodiments, b+d=0.68−x and c=0.25+x, where x is 0 to 0.25. In some examples, x is 0 to 0.15.

In some embodiments, d is at least 0.025, 0.05, 0.075, 0.1, 0.15, 0.2 or 0.25. In some embodiments, d is no more than 0.35, 0.3, 0.25, 0.2, 0.15 or 0.10. In some embodiments, 0≤d≤0.35, 0≤d≤0.3, or 0≤d≤0.25. For example, d may be 0, 0.05, 0.06, 0.07, 0.08, 0.09, 0.10, 0.11, 0.12, 0.13, 0.14, 0.15, 0.16, 0.17, 0.18, 0.19, or 0.20.

In some embodiments, e is at least 0.01, 0.015, 0.02, 0.025, 0.03, 0.035, 0.04, 0.045, 0.05, 0.055, or 0.06. For example, e may be at least 0.02, 0.03, 0.04, or 0.05. In some embodiments, e is no more than 0.20, 0.18, 0.16, 0.14, 0.12, or 0.1. In some embodiments, 0.02≤e≤0.2, 0.03≤e≤0.15, 0.04≤e≤0.1, 0.05≤e≤0.09. In some embodiments, 0.05≤e≤0.1. For example, e may be 0.01, 0.02, 0.03, 0.04, 0.05, 0.06, 0.07, 0.08, 0.09, 0.1, 0.11, 0.12, 0.13, 0.14, or 0.15.

In some embodiments, z is at least 0.01, 0.015, 0.02, 0.025, 0.03, 0.035, 0.04, 0.045, 0.05, 0.055, or 0.06. For example, z may be at least 0.02, 0.03, 0.04, or 0.05. In some embodiments, z is no more than 0.20, 0.18, 0.16, 0.14, 0.12, or 0.1. In some embodiments, 0≤z≤0.2, 0≤z≤0.15, 0≤z≤0.1, 0≤z≤0.09. In some embodiments, 0.05≤z≤0.1. For example, z may be 0, 0.01, 0.02, 0.03, 0.04, 0.05, 0.06, 0.07, 0.08, 0.09, 0.1, 0.11, 0.12, 0.13, 0.14, or 0.15.

In some embodiments, e+z is at least 0.01, 0.015, 0.02, 0.025, 0.03, 0.035, 0.04, 0.045, 0.05, 0.055, or 0.06. For example, e+z may be at least 0.02, 0.03, 0.04, or 0.05. In some embodiments, e+z is no more than 0.24, 0.22, 0.20, 0.18, or 0.17. In some embodiments, 0<e+z≤0.24, 0<e+z≤0.22, 0<e+z≤0.20, 0<e+z≤0.18. In some embodiments, 0.05≤e+z≤0.18. For example, e+z may be 0.01, 0.02, 0.03, 0.04, 0.05, 0.06, 0.07, 0.08, 0.09, 0.1, 0.11, 0.12, 0.13, 0.14, 0.15, 0.16 or 0.17.

In some embodiments, 0.6≤a≤0.9; and/or 0.2≤b≤0.7; and/or 0.2≤c≤0.5. In some embodiments, 0.6≤a≤0.9; and 0.2≤b≤0.7; and 0.2≤c≤0.5.

In specific embodiments, 0.7≤a≤0.9; and/or 0.2≤b≤0.7; and/or 0.2≤c≤0.5. In even more specific embodiments, 0.7≤a≤0.9; and 0.2≤b≤0.7; and 0.2≤c≤0.5.

In some embodiments, b+d≤0.7, b+d≤0.69, or b+d≤0.68. In some embodiments, 0.6≤a≤0.9; b+d≤0.7; 0.25≤c≤0.4; and/or 0≤e+z≤0.2. In more specific embodiments, 0.6≤a≤0.9; b+d≤0.7; 0.25≤c≤0.4; and 0<e+z≤0.2.

In some embodiments, b=c. For example, in some embodiments, b=0.4 and c=0.4, or b=0.35 and c=0.35. Alternatively, b may be greater or less than c. Often, b is greater than c. In some embodiments, d=e. For example, in some embodiments, d=0.1 and e=0.1, or d=0.2 and e=0.2. Alternatively, d may be greater or less than e. Often, d is less than e. For example, in some embodiments, d=0.1 and e=0.2.

As described above, b+c+d+e+z≤1. In some embodiments, b+c+d+e+z=1. Where b+c+d+e+z<1, vacancies are incorporated into the material.

In some embodiments, b+c+d+e≤1. In some embodiments, b+c+d+e=1. In some embodiments, where b+c+d+e<1, vacancies are incorporated into the material.

In particular embodiments, d+z>0, i.e. the material of the invention comprises titanium and/or M2. In some embodiments, z>0, i.e. the material of the invention comprises M2.

In some embodiments, d>0, i.e. the material of the invention comprises titanium. In particular embodiments, z>0 and d>0, i.e. the material of the invention comprises both M2 and titanium.

In particular embodiments, the material may have the general formula:

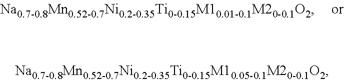

where M1 and M2 are as defined above.

In some embodiments, the material may have the general formula:

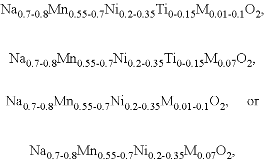

where M is as defined above. For example, M may consist of one element selected from zinc, aluminium and copper and optionally one or more other, different, elements selected from magnesium, zinc, aluminium and copper.

For example, the material may have formula:

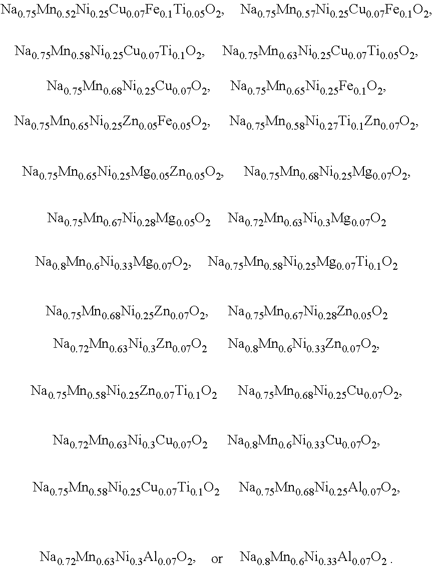

In some embodiments, M comprises any one or more elements selected from the group consisting of magnesium and zinc. In more particular embodiments, M is magnesium or zinc. In alternative embodiments, M consists of one element selected from zinc, aluminium and copper and optionally one or more other, different, elements selected from magnesium, zinc, aluminium and copper. For example, M may consist of zinc or copper and optionally one or more other different elements selected from magnesium, zinc and copper.

In some embodiments, M comprises two or more of magnesium, zinc, aluminium and copper. For example, M may comprise magnesium and zinc, magnesium and copper, or copper and zinc. Alternatively, M may comprise magnesium and aluminium, zinc and aluminium, or copper and aluminium. For the avoidance of doubt, where M comprises two or more metals, e is equal to the sum of the proportions of each of the two or more metals. For example, where M comprises a ratio f of magnesium and a ratio g of aluminium, e is equal to f+g. Thus, where e=0.07, f+g=0.07.

In some embodiments, M1 is an element selected from iron, copper and zinc. In more particular embodiments, M1 is an element selected from iron and copper.

In some embodiments, M2 consists of one or more elements different to M1 and selected from iron, copper, zinc and magnesium.

In particular embodiments, where z>0, M1 is copper and M2 is iron, M1 is zinc and M2 is iron; or M1 is zinc and M2 is magnesium.

In some cases, the material comprises further dopants in addition to those specified in the general formulae disclosed herein. For example, the material may comprise lithium as a further dopant, in addition to zinc, aluminium and/or copper. In such examples, the material may be of the following formula:

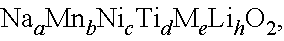

where M is zinc, aluminium and/or copper, a, b, c, d and e are as defined above and 0≤h≤0.25.

In some cases, the material is of the following formula:

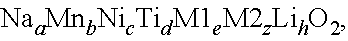

wherein:
M1, M2, a, b, c, d, e, and z are as defined above and 0≤h≤0.25.

In some examples, h is at least 0.01, 0.015, 0.02, 0.025, 0.03, 0.035, 0.04, 0.045, 0.05, 0.055, or 0.06. In some embodiments, h is no more than 0.20, 0.18, 0.16, 0.14, 0.12, or 0.1. In some embodiments, 0.02≤h≤0.2, 0.03≤h≤0.15, 0.04≤h≤0.1, 0.05≤h≤0.09. For example, h may be 0.01, 0.02, 0.03, 0.04, 0.05, 0.06, 0.07, 0.08, 0.09, 0.1, 0.11, 0.12, 0.13, 0.14, or 0.15.

In some cases, b+c+d+e+h≤1, e.g. b+c+d+e+h=1.

In some cases, b+c+d+e+z+h≤1, e.g. b+c+d+e+z+h=1.

As described above, the material of the invention has at least a P2-type and a P3-type phase. Other phases, such as an O3-type phase may also be present. Alternatively, the material may consist only of P2-type and P3-type phases.

In some embodiments, the layered sodium metal oxide material comprises from 0.5 to 99.5% of the P2-type phase and from 99.5 to 0.5% of the P3-type. Therefore, the layered sodium metal oxide material of the present invention may be P2/P3 bi-phasic (i.e. with a higher proportion of the P2-type phase than the P3-type phase) or P3/P2 bi-phasic (i.e. with a higher proportion of the P3-type phase than the P2-type phase).

In accordance with a second aspect of the invention, there is provided an electrode comprising the layered sodium metal oxide material as described above in accordance with the first aspect.

In accordance with a third aspect of the invention, there is provided an energy storage device comprising the layered sodium metal oxide material as described above in accordance with the first aspect. In some embodiments, the energy storage device is a sodium-ion battery.

In accordance with a fourth aspect of the invention, there is provided a method of forming the material of the first aspect, the method comprising:
(a) providing a metal salt solution, the metal salt including salts of Na, Mn, Ni, and M1;
(b1) optionally mixing a Ti source with the metal salt solution;
(b2) optionally mixing a salt of M2 with the metal salt solution
(c) mixing a gelator with the metal salt solution to form a sol-gel solution;
(d) heating the sol-gel solution to form a gel; and
(e) subjecting the gel to calcination to obtain the material;
wherein M1 is an element selected from iron, copper, zinc, and aluminium; and M2 consists of one or more elements different to M1 and selected from iron, copper, zinc, magnesium and aluminium.

Alternatively, the method may comprise:
(a) providing a metal salt solution, the metal salt including salts of Na, Mn, Ni, and M;
(b) optionally mixing a Ti source with the metal salt solution;
(c) mixing a gelator with the metal salt solution to form a sol-gel solution;
(d) heating the sol-gel solution to form a gel; and
(e) subjecting the gel to calcination to obtain the material;
wherein M comprises one or more elements selected from the group consisting of magnesium, zinc, aluminium, and copper.

In some embodiments, a stoichiometric quantity of each metal salt is used. In some embodiments, an excess of the Na salt is used. In some embodiments, the metal salts are nitrates. The sodium salt may be provided in excess. The excess may be from around 1 wt % to around 10 wt %. The excess may be 1 wt %, 2 wt %, 3 wt %, 4 wt %, 5 wt %, 6 wt %, 7 wt %, 8 wt %, 9 wt %, or 10 wt %.

The method may include cooling the sodium metal oxide material.

The gelator may be any molecule suitable for chelating with the metal salts to form a gel-like substance, e.g. a chelating agent. In some embodiments, the gelator comprises a carboxylic acid. For example, the carboxylic acid may comprise one or more acids selected from the group consisting of: citric acid, ethylenediaminetetraacetic acid (EDTA), tartaric acid, glycolic acid, oxalic acid. In some embodiments, the gelator comprises one or more monosaccharides, such as glucose. In some embodiments, the gelator comprises one or more amino acids, such as glutamine or histidine. In a preferred embodiment, the gelator comprises a carboxylic acid, such as citric acid.

In some embodiments, the stoichiometric ratio of gelator to metal salts is 1:1. In some embodiments, the gelator is added to the metal salt solution in the form of an aqueous solution. In some embodiments, the metal salt solution is allowed to homogenise before adding the gelator. In some embodiments, the sol-gel solution is allowed to homogenise after adding the gelator. Homogenisation may be achieved by stirring for a suitable amount of time, e.g. from several minutes up to several hours.

In some embodiments, step (d) includes heating the sol-gel solution at a temperature from 60 to 100° C. to form a gel. In some embodiments, the sol-gel solution is heated at a temperature of at least 60, 65, 70, 75, 80, 85, 90 or 95° C. to form a gel. In some embodiments, the sol-gel solution is heated at a temperature of no more than 100, 95, 90, 85, 80, 75, 70 or 65° C. to form a gel. In some embodiments, the sol-gel solution is heated at a temperature from 65 to 95° C., from 70 to 90° C. or from 75 to 85° C. to form a gel. In some embodiments, the sol-gel solution is heated at a temperature of 80° C. to form a gel.

In some embodiments, step (d) includes heating the sol-gel solution for 2 to 24 hours to form a gel. In some embodiments, the sol-gel solution is heated for at least 2, 4, 6, 8, 10, 12, 14, 16, 18, 20 or 22 hours to form a gel. In some embodiments, the sol-gel solution is heated for no more than 22, 20, 18, 16, 14, 12, 10, 8, 6, or 4 hours to form a gel. In some embodiments, the sol-gel solution is heated for 2 to 18 hours, for 2 to 12 hours, or for 2 to 6 hours to form a gel.

In some embodiments, the gel is dried before being subjected to calcination, i.e. in some embodiments, step (d) includes drying the gel formed. In particular embodiments, the gel is dried at temperatures of no greater than 150° C. In some embodiments, the gel is dried at temperatures no less than 100° C. In some embodiments, the gel is dried at temperatures of 100 to 150° C., such as 110 to 140° C., 120 to 140° C. or 125 to 135° C.

In some embodiments, the gel is ground to a powder before being subjected to calcination.

In some embodiments, step (e) includes subjecting the gel to calcination in an oxidising atmosphere. For example, the oxidising atmosphere may be air or oxygen.

In some embodiments, the step of calcining the gel may be performed at three different temperatures. For example, in some embodiments, step (e) includes:
(f) calcining the gel at a first temperature of 400 to 800° C., then
(g) calcining the gel one or more times at a second temperature of 600 to 1000° C., and then
(h) calcining the gel at a third temperature of 400 to 600° C.

In some embodiments, the first temperature is at least 400, 425, 450, 475 or 500° C. In some embodiments, the first temperature is no more than 800, 775, 750, 725 or 700° C. In some embodiments, the first temperature is from 450 to 750° C. In some embodiments, the first temperature is from 400 to 700° C., such as 450 to 550° C.

In some embodiments, the second temperature is at least 600, 650, or 700° C. In some embodiments, the second temperature is no more than 1000 or 950° C. In some embodiments, the second temperature is from 650 to 950° C., from 670 to 940° C., or from 690 to 940° C. In some embodiments, the second temperature is from 700 to 930° C. It will be understood that the exact temperature used will depend on the ratio of P2:P3 that the layered metal oxide material should comprise. For example, higher ratios of the P3-type phase may require lower temperatures than the temperatures used for higher ratios of the P2-type phase.

In some embodiments, the third temperature is at least 400, 425, or 450° C. In some embodiments, the third temperature is no more than 600, 575 or 550° C. In some embodiments, the first temperature is from 450 to 550° C.

In some embodiments, step (f) includes calcining the gel at the first temperature for 2 to 6 hours, e.g. 5 hours, step (g) includes calcining the gel one or more times at the second temperature for 0.5 to 20 hours, e.g. for 2 to 6 hours per second temperature totaling, for example, 2 to 15 hours, and step (h) includes calcining the gel one or more times at the third temperature for 0.5 to 20 hours, e.g. 2 to 18 hours. In some embodiments, step (e) includes calcining the gel for a total of at least 5, 6, 8, 10, 12, 15 or 18 hours. In some embodiments, step (e) includes calcining the gel for no more than 40, 36, 32, 28, 24, 20, 18, 15, 12, or 10 hours. It will be understood that the exact duration of the calcination will depend on the ratio of P2:P3 that the layered metal oxide material should comprise.

In some embodiments, the step of calcining the gel is performed using a heating rate of 5° C./min.

In some embodiments, the sodium metal oxide material may be ground into a powder after cooling. In some embodiments, the sodium metal oxide material may be ground into a powder after cooling to 250° C. to 300° C., e.g. 250° C. In some embodiments, the sodium metal oxide material may be ground under an inert atmosphere, e.g. argon.

According to a further aspect of the invention, there is provided a layered sodium metal oxide material produced by the method of the fourth aspect.

It will be appreciated that features of any one of the aspects of the present invention may be combined with features of any of the other aspects of the present invention except where there is technical incompatibility. All such combinations are explicitly considered and disclosed herein.

### CLAUSES

The invention may be understood by reference to the following clauses.

Clause 1. A layered sodium metal oxide material having at least a P2-type phase and a P3-type phase, the material having the general formula:

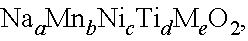

wherein:
M comprises one or more elements selected from the group consisting of magnesium, zinc, aluminium and copper; and
   wherein:

$$0.5 < a \leq 1 ;$$

$$0 \leq b \leq 0.7 ;$$

$$0 < c \leq 0.5 ;$$

$$0 \leq d \leq 0.4 ;$$

$$0 < e \leq 0.25 ; and$$

$$b + c + d + e \leq 1.$$

Clause 2. The material of clause 1, wherein:

$$0.6 \leq a \leq 0.9 ; and / or$$

$$0. 2 \leq b \leq 0.7 ; and / or$$

$$0.2 \leq c \leq 0.5 .$$

Clause 3. The material of clause 1 or clause 2, wherein:

$$0.6 \leq a \leq 0.9 ;$$

$$b + d \leq 0.7 ;$$

$$0.25 \leq c \leq 0.4 ; and / or$$

$$0 < e \leq 0.15 .$$

Clause 4. The material of any one preceding clause, wherein M comprises any one or more elements selected from the group consisting of magnesium and zinc.

Clause 5. The material of clause 4, wherein M is magnesium or zinc.

Clause 6. The material of any one preceding clause, wherein the material comprises 0.1 to 99.9 wt % of the P2-type phase and 99.9 to 0.1 wt % of the P3-type phase.

Clause 7. An electrode comprising the material of any one preceding clause.

Clause 8. An energy storage device comprising the material of any one of clauses 1 to 6 or the electrode of clause 7, optionally wherein the energy storage device is a sodium-ion battery.

Clause 9. A method of forming material as defined in any one of clauses 1 to 6, the method comprising:
(a) providing a metal salt solution, the metal salts including salts of Na, Mn, Ni, and M;
(b) optionally mixing a Ti source with the metal salt solution;
(c) mixing a gelator with the metal salt solution to form a sol-gel solution;
(d) heating the sol-gel solution to form a gel; and
(e) subjecting the gel to calcination to obtain the material;
wherein M comprises one or more elements selected from the group consisting of magnesium, zinc, aluminium, and copper.

Clause 10. The method of clause 9, wherein the gelator is a carboxylic acid, optionally wherein the carboxylic acid is citric acid.

Clause 11. The method of clause 9 or clause 10, wherein the stoichiometric ratio of gelator to metal salts is 1:1.

Clause 12. The method of any one of clauses 9 to 11, wherein step (d) includes heating the sol-gel solution to a temperature from 60 to 100° C., optionally wherein step (d) includes heating the sol-gel solution for 2 to 24 hours.

Clause 13. The method of any one of clauses 9 to 12, wherein step (d) includes drying the gel formed at temperatures of 100 to 150° C.

Clause 14. The method of any one of clauses 9 to 13, wherein step (e) includes subjecting the gel to calcination in an oxidising atmosphere, optionally wherein the oxidising atmosphere is air or oxygen.

Clause 15. The method of any one of clauses 9 to 14, wherein step (e) includes:
(f) calcining the gel at a first temperature of 400 to 800° C., then
(g) calcining the gel one or more times at a second temperature of 600 to 1000° C., and then
(h) calcining the gel at a third temperature of 400 to 600° C.

Clause 16. The method of clause 15, wherein step (f) includes calcining the gel at the first temperature for 2 to 6 hours and step (g) includes calcining the gel one or more times at the second temperature for 0.5 to 20 hours.

### EXAMPLES

### Synthesis of layered sodium metal oxide material comprising magnesium

Five materials based on the chemistry Na_{0.72-0.75}Mn_{0.63-0.68}Ni_{0.25-0.3}Mg_{0.07}O₂, with different P2:P3 ratios of 0.3:0.7, 0.6:0.4, 0.24:0.76, 0.54:0.46 and 0.41:0.59 were synthesised using a citric acid sol-gel method. The target composition of the materials is detailed in Table 1.

Two materials based on the chemistry Na_{0.75}Mn_{0.68}Ni_{0.25}Mg_{0.07}O₂, with different P2:P3 mass ratios of 0.3:0.7 and 0.6:0.4, (calculated by Rietveld Refinement), were synthesised using a citric acid sol-gel method. Stoichiometric amounts of sodium nitrate, manganese nitrate, nickel nitrate and magnesium nitrate were dissolved in de-ionised (DI) water and stirred for 10 mins. A 2 wt % excess of sodium nitrate was used. Citric acid was dissolved in a separate beaker (1:1 citric acid to metal ratio) and then added to the nitrate solution dropwise. After stirring for 2 hours, the solution was heated to 80° C. overnight for gel formation. The gel was then dried at 130° C. for 6 hours, before being ground in a pestle and mortar and calcined. The dry gel was calcined at 450° C. for 5 hours followed by:
a) 3 hours at 840° C. and 5 hours at 500° C. before cooling to 250° C. to obtain a P2:P3 mass ratio of 0.3:0.7.
b) 3 hours at 860° C. and 5 hours at 500° C. before cooling to 250° C. to obtain a P2:P3 mass ratio of 0.6:0.4.

A heating/cooling of 5° C. min⁻¹ was used. Once cooled to 250° C., the samples were removed and ground in a dry room before transferring to an argon-filled glovebox.

Three materials based on the chemistry Na_{0.72}Mn_{0.63}Ni_{0.30}Mg_{0.07}O₂, with different P2:P3 mass ratios of 0.24:0.76, 0.54:0.46 and 0.41:0.59, (calculated by Rietveld Refinement), were synthesised using a citric acid sol-gel method. Stoichiometric amounts of sodium nitrate, manganese nitrate, nickel nitrate and magnesium nitrate were dissolved in de-ionised (DI) water and stirred for 10 mins. A 2 wt % excess of sodium nitrate was used. Citric acid was dissolved in a separate beaker (1:1 citric acid to metal ratio) and then added to the nitrate solution dropwise. After stirring for 2 hours, the solution was heated to 80° C. overnight for gel formation. The gel was then dried at 130° C. for 6 hours, before being ground in a pestle and mortar and calcined. The dry gel was calcined at 450° C. for 5 hours followed by
a) 3 hours at 700° C., 3 hours at 800° C., 3 hours at 840° C., and 5 hours at 500° C. before cooling to 250° C. to obtain a P2:P3 mass ratio of 0.24:0.76.
b) 3 hours at 700° C., 3 hours at 800° C., 3 hours at 840° C., 3 hours at 860° C. and 5 hours at 500° C. before cooling to 250° C. to obtain a P2:P3 mass ratio of 0.54:0.46.
c) 3 hours at 780° C., 5 hours at 500° C., 3 hours at 860° C., and 15 hours at 500° C. before cooling to 250° C. to obtain a P2:P3 mass ratio of 0.41:0.59

A heating/cooling of 5° C. min⁻¹ was used. Once cooled to 250° C., the samples were removed and ground in a dry room before transferring to an argon-filled glovebox.

TABLE 1
Chemical composition, calcination conditions and
resultant phase composition of the layered sodium
metal oxide materials comprising magnesium

| | | Phase |
|---|---|---|
| | | composition |
| Composition | Calcination Conditions | (P2:P3 ratio) |
| Na_{0.75}Mn_{0.68}Ni_{0.25}Mg_{0.07}O₂ | 840° C./3 hours, | 0.3:0.7 |
| | 500° C./5 hours | |
| Na_{0.75}Mn_{0.68}Ni_{0.25}Mg_{0.07}O₂ | 860° C./3 hours, | 0.6:0.4 |
| | 500° C./5 hours | |
| Na_{0.72}Mn_{0.63}Ni_{0.3}Mg_{0.07}O₂ | 700° C./3 hours, | 0.24:0.76 |
| | 800° C./3 hours, | |
| | 840° C./3 hours, | |
| | 500° C./5 hours | |
| Na_{0.72}Mn_{0.63}Ni_{0.3}Mg_{0.07}O₂ | 700° C./3 hours, | 0.54:0.46 |
| | 800° C./3 hours, | |
| | 840° C./3 hours, | |
| | 860° C./3 hours, | |
| | 500° C./5 hours | |
| Na_{0.72}Mn_{0.63}Ni_{0.3}Mg_{0.07}O₂ | 780° C./3 hours, | 0.41:0.59 |
| | 500° C./5 hours/ | |
| | 860° C./3 hours, and | |
| | 500° C./15 hours | |
| Na_{0.75}Mn_{0.68}Ni_{0.25}Mg_{0.07}O₂ | 740° C./3 hours, | 1.0:0.0 |
| | 500° C./5 hours | |
| Na_{0.75}Mn_{0.68}Ni_{0.25}Mg_{0.07}O₂ | 930° C./3 hours | 0.0:1.0 |

### Material Characterisation

Powder x-ray diffraction (XRD) patterns were obtained using a Stoe STADIP diffractometer in Debye-Scherrer geometry with Mo Kα₁ radiation (λ=0.7093 Å). Structures were refined by the Rietveld method using Topas Academic.

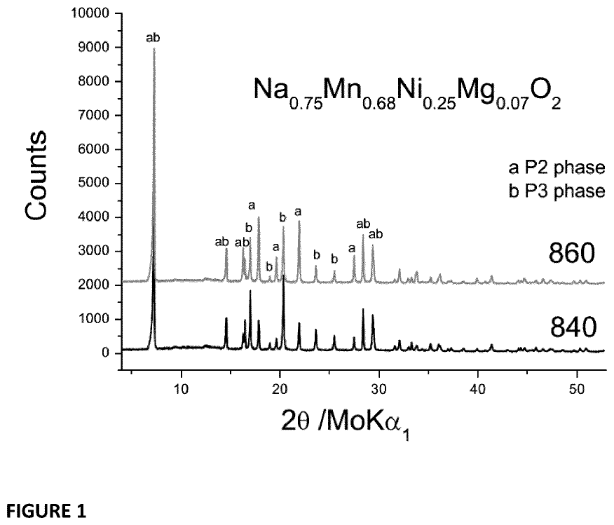

The results are shown in FIG. 1, showing the full range of diffraction peaks collected from 4-54 degrees 2θ for the first two entries of Table 1. The peaks for the respective phases are indicated in the figure and shown in Table 2.

TABLE 2

| | | | | |
|---|---|---|---|---|
| | | | d | |
| h | k | l | spacing | 2θ |

a) Reflections corresponding to the P2 phase
in Na_{0.75}Mn_{0.68}Ni_{0.25}Mg_{0.07}O₂

| | | | | |
|---|---|---|---|---|
| 0 | 0 | 2 | 5.577 | 7.291 |
| 0 | 0 | 4 | 2.789 | 14.612 |
| 1 | 0 | 0 | 2.503 | 16.288 |
| 1 | 0 | 1 | 2.443 | 16.696 |
| 1 | 0 | 2 | 2.284 | 17.866 |
| 1 | 0 | 3 | 2.077 | 19.666 |
| 1 | 0 | 4 | 1.863 | 21.949 |
| 0 | 0 | 6 | 1.859 | 21.994 |
| 1 | 0 | 5 | 1.666 | 24.588 |
| 1 | 0 | 6 | 1.493 | 27.491 |
| 2 | −1 | 0 | 1.445 | 28.407 |
| 2 | −1 | 2 | 1.399 | 29.366 |
| 0 | 0 | 8 | 1.394 | 29.470 |
| 1 | 0 | 7 | 1.344 | 30.593 |
| 2 | −1 | 4 | 1.283 | 32.087 |
| 2 | 0 | 0 | 1.252 | 32.918 |
| 2 | 0 | 1 | 1.244 | 33.130 |
| 2 | 0 | 2 | 1.221 | 33.761 |
| 1 | 0 | 8 | 1.218 | 33.852 |
| 2 | 0 | 3 | 1.186 | 34.789 |
| 2 | 0 | 4 | 1.142 | 36.186 |
| 2 | −1 | 6 | 1.141 | 36.214 |
| 0 | 0 | 10 | 1.115 | 37.076 |
| 1 | 0 | 9 | 1.111 | 37.240 |
| 2 | 0 | 5 | 1.092 | 37.916 |

b) Reflections corresponding to the P3 phase
in Na_{0.75}Mn_{0.68}Ni_{0.25}Mg_{0.07}O₂

| | | | | |
|---|---|---|---|---|
| 0 | 0 | 3 | 5.598 | 7.265 |
| 0 | 0 | 6 | 2.799 | 14.559 |
| 1 | 0 | 1 | 2.475 | 16.478 |
| 1 | 0 | −2 | 2.398 | 17.011 |
| 1 | 0 | 4 | 2.149 | 18.995 |
| 1 | 0 | −5 | 2.007 | 20.361 |
| 0 | 0 | 9 | 1.866 | 21.913 |
| 1 | 0 | 7 | 1.732 | 23.636 |
| 1 | 0 | −8 | 1.608 | 25.480 |
| 2 | −1 | 0 | 1.445 | 28.423 |
| 0 | 0 | 12 | 1.399 | 29.359 |
| 2 | −1 | 3 | 1.399 | 29.375 |
| 1 | 0 | 10 | 1.394 | 29.469 |
| 1 | 0 | −11 | 1.303 | 31.582 |
| 2 | −1 | 6 | 1.284 | 32.076 |
| 2 | 0 | −1 | 1.248 | 33.030 |
| 2 | 0 | 2 | 1.237 | 33.311 |
| 2 | 0 | −4 | 1.199 | 34.411 |
| 2 | 0 | 5 | 1.172 | 35.217 |
| 1 | 0 | 13 | 1.148 | 35.994 |
| 2 | −1 | 9 | 1.142 | 36.176 |
| 0 | 0 | 15 | 1.120 | 36.935 |
| 2 | 0 | −7 | 1.109 | 37.291 |
| 1 | 0 | −14 | 1.082 | 38.279 |
| 2 | 0 | 8 | 1.075 | 38.538 |

### Electrochemical Characterisation

To investigate the electrochemical performance of the materials, slurries were prepared using the active material synthesised by the method above, super C65 carbon and Solef 5130 binder (a modified polyvinylidene fluoride (PVDF)), in the mass ratio 80:10:10, in n-methyl-2-pyrrolidone (NMP). The slurry was cast onto aluminum foil using a doctor blade. After drying, 10 mm diameter electrode discs were punched and used to prepare CR2032 coin cells. All slurry processing, casting, drying, punching and coin cell assembly was carried out in an argon-filled glovebox (O₂<0.1 ppm, H₂O<0.1 ppm). Sodium metal was used as a counter/reference electrode, a glass fiber paper (Whatman, GF/F) was used as the separator and 1 M NaPF₆ in EC/DEC was used as the electrolyte. Galvanostatic charge/discharge cycling and cyclic voltammetry were carried out at 30° C. using a Biologic BCS-805 battery cycler or Neware BTS-4000 battery cycler.

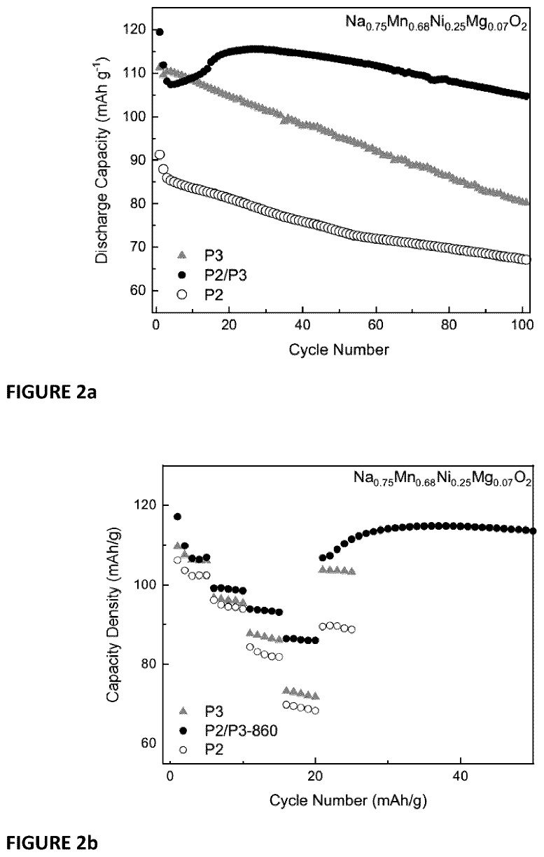

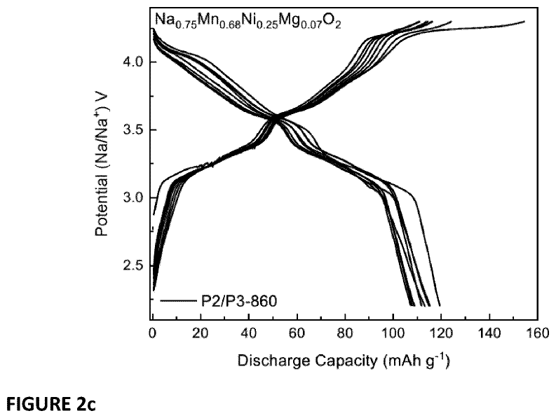

The resulting load curve of the material of the second entry in Table 1 is shown in FIG. 2c. The main region corresponds to the Ni²⁺/Ni³⁺ and Ni³⁺/Ni⁴⁺ redox couples, with a high voltage region (ca. >3.8 V) believed to result from reversible oxidation of O²⁻.

In each case, the initial charge capacity was significantly higher than the initial discharge capacity, confirming that the materials all contained sufficient Na for use in a full cell, and do not rely on additional Na from the metallic counter electrode to achieve high capacities in half cell format. The initial charge capacity was 154 mAh g⁻¹ in this example. The initial discharge capacities were higher for the bi-phasic materials compared to the pure phase materials, with the P2/P3 materials having an initial discharge capacity of 120 mAh g⁻¹, compared to 112 and 92 mAh g⁻¹ for the pure phase P3 and P2 materials, respectively. This suggests that the bi-phasic materials have higher initial electrochemical activity compared to the pure phase materials, and that the same result could not be achieved by simply physically combining the two pure phase materials.

FIG. 2a shows a comparison of the cycling performances of the material of the invention (of the second entry in Table 1 comprising a P2-type and a P3-type phase) and reference materials comprising only P2-type and P3-type phases. The P3 phase was made by the sol-gel synthesis described above with a calcination temperature of 740° C. The P2 phase was made by the sol-gel synthesis described above with a calcination temperature of 930° C. As shown in FIG. 2a, over subsequent cycles the material of the invention (of the second entry in Table 1 comprising a P2-type and a P3-type phase) and the reference material comprising only a P3-type phase initially underwent a slight decrease in their capacities followed by an increase and finally a further decrease. This effect was greatest in the P2/P3 material, which saw an increase in capacity from 119 to 108 mAh g⁻¹ over the first 5 cycles, before rising to 116 mAh g⁻¹ around cycle 30 and beginning to gradually fade thereafter. The pure phase P2 material showed a decrease in capacity throughout. After 100 cycles, the P2/P3 material showed the highest cycling stability, with 90% of the maximum capacity retained.

As shown in FIG. 2b, rate capability testing of the material of the invention, second entry in Table 1, (carried out at 25, 100, 200 and 500 mA g⁻¹) revealed that the high rate performance was significantly enhanced in the P2/P3 material especially at 500 mA g⁻¹ compared to the pure phase P2 and P3 materials (86 mAh g⁻¹ compared to 72 mA g⁻¹ for the P3 material and 68 mA g⁻¹ for the P2 material. Overall, the P2/P3 material showed the best rate capability with capacities of 108, 99, 93 and 86 mAh g⁻¹ at 25, 100, 200 and 500 mA g⁻¹ respectively, compared to 107, 96, 87, and 72 mAh g⁻¹ for the pure phase P3 material, and 102, 94, 82 and 68 mAh g⁻¹ for the pure phase P2 material. These results confirmed that the bi-phasic materials have higher capacities than the pure phase materials and superior rate performance.

### Summary of Layered Sodium Metal Oxide Materials Comprising Magnesium

A series of layered oxides based on the chemistry Na_{0.72-0.75}Mn_{0.63-0.68}Ni_{0.25-0.3}Mg_{0.07}O₂, with different P2:P3 ratios was synthesised using a citric acid sol-gel method and tested in electrochemical cells. When cycled between 2.2-4.3 V vs. Na⁺/Na at 25 mA g⁻¹, all materials showed excellent performance, with initial discharge capacities ranging from about 115 to 140 mAh g⁻¹, high average voltages (around 3.5V) and excellent capacity retention over at least 100 cycles (FIG. 2).

### Synthesis of Layered Sodium Metal Oxide Material Comprising Zinc

Three materials based on the chemistry Na_{0.75}Mn_{0.68}Ni_{0.25}Zn_{0.07}O₂, with different P2:P3 ratios of 0.4:0.6, 0.45:0.55, 0.85:0.15 were synthesised using the citric acid sol-gel method described above. The target composition of the materials is detailed in Table 3.

TABLE 3
Chemical composition, calcination conditions
and resultant phase composition of the layered
sodium metal oxide materials comprising zinc

| | | Phase composition |
|---|---|---|
| Composition | Calcination Conditions | (P2:P3 ratio) |
| Na_{0.75}Mn_{0.68}Ni_{0.25}Zn_{0.07}O₂ | 820° C./3 hours, | 0.4:0.6 |
| | 500° C./5 hours | |
| Na_{0.75}Mn_{0.68}Ni_{0.25}Zn_{0.07}O₂ | 840° C./3 hours, | 0.45:0.55 |
| | 500° C./5 hours | |
| Na_{0.75}Mn_{0.68}Ni_{0.25}Zn_{0.07}O₂ | 860° C./3 hours, | 0.85:0.15 |
| | 500° C./5 hours | |

### Material Characterisation

Powder x-ray diffraction (XRD) patterns were obtained using a PANalytical Empyrean diffractometer in Bragg-Brentano geometry with Cu Kα₁ radiation (λ=1.5406 Å) Structures were refined by the Rietveld method using Topas Academic.

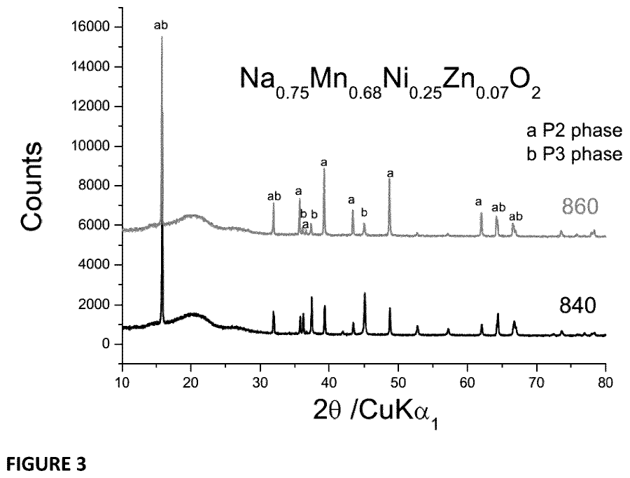

The results are shown in FIG. 3, showing the full range of diffraction peaks collected from 10-80 degrees 2θ for the final two entries of Table 3. The peaks for the respective phases are indicated in the figure and shown in Table 4.

TABLE 4

| | | | | |
|---|---|---|---|---|
| | | | d | |
| h | k | l | spacing | 2θ |

a) Reflections corresponding to the P2 phase
in Na_{0.75}Mn_{0.68}Ni_{0.25}Zn_{0.07}O₂

| | | | | |
|---|---|---|---|---|
| 0 | 0 | 2 | 5.577 | 15.878 |
| 0 | 0 | 4 | 2.789 | 32.072 |
| 1 | 0 | 0 | 2.506 | 35.800 |
| 1 | 0 | 1 | 2.445 | 36.724 |
| 1 | 0 | 2 | 2.286 | 39.384 |
| 1 | 0 | 3 | 2.078 | 43.513 |
| 1 | 0 | 4 | 1.864 | 48.818 |
| 0 | 0 | 6 | 1.859 | 48.958 |
| 1 | 0 | 5 | 1.666 | 55.068 |
| 1 | 0 | 6 | 1.493 | 62.116 |
| 2 | −1 | 0 | 1.447 | 64.329 |
| 2 | −1 | 2 | 1.401 | 66.731 |
| 0 | 0 | 8 | 1.394 | 67.074 |
| 1 | 0 | 7 | 1.345 | 69.899 |
| 2 | −1 | 4 | 1.284 | 73.705 |
| 2 | 0 | 0 | 1.253 | 75.862 |
| 2 | 0 | 1 | 1.245 | 76.424 |
| 2 | 0 | 2 | 1.223 | 78.105 |
| 1 | 0 | 8 | 1.218 | 78.428 |

b) Reflections corresponding to the P3 phase
in Na_{0.75}Mn_{0.68}Ni_{0.25}Zn_{0.07}O₂

| | | | | |
|---|---|---|---|---|
| 0 | 0 | 3 | 5.588 | 15.846 |
| 0 | 0 | 6 | 2.794 | 32.005 |
| 0 | 0 | 9 | 1.863 | 48.852 |
| 0 | 0 | 12 | 1.397 | 66.920 |
| 1 | 0 | −11 | 1.302 | 72.544 |
| 1 | 0 | −8 | 1.607 | 57.273 |
| 1 | 0 | −5 | 2.007 | 45.146 |
| 1 | 0 | −2 | 2.400 | 37.442 |
| 1 | 0 | 1 | 2.477 | 36.232 |
| 1 | 0 | 4 | 2.150 | 41.987 |
| 1 | 0 | 7 | 1.731 | 52.845 |
| 1 | 0 | 10 | 1.393 | 67.130 |
| 2 | −1 | 0 | 1.446 | 64.370 |
| 2 | −1 | 3 | 1.400 | 66.761 |
| 2 | −1 | 6 | 1.284 | 73.706 |
| 2 | 0 | −4 | 1.200 | 79.871 |
| 2 | 0 | −1 | 1.249 | 76.161 |
| 2 | 0 | 2 | 1.239 | 76.907 |

### Electrochemical Characterisation

To investigate the electrochemical performance of the materials, slurries were prepared as described above. Galvanostatic charge/discharge cycling was carried out as described above.

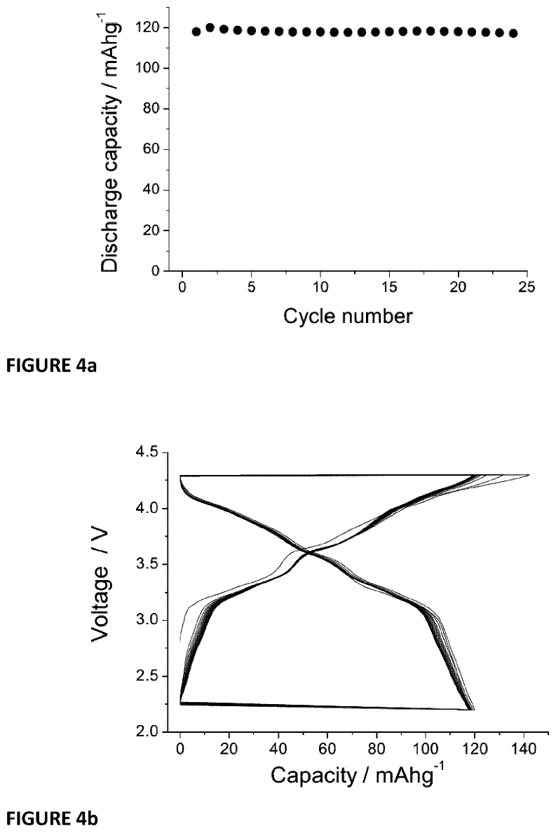

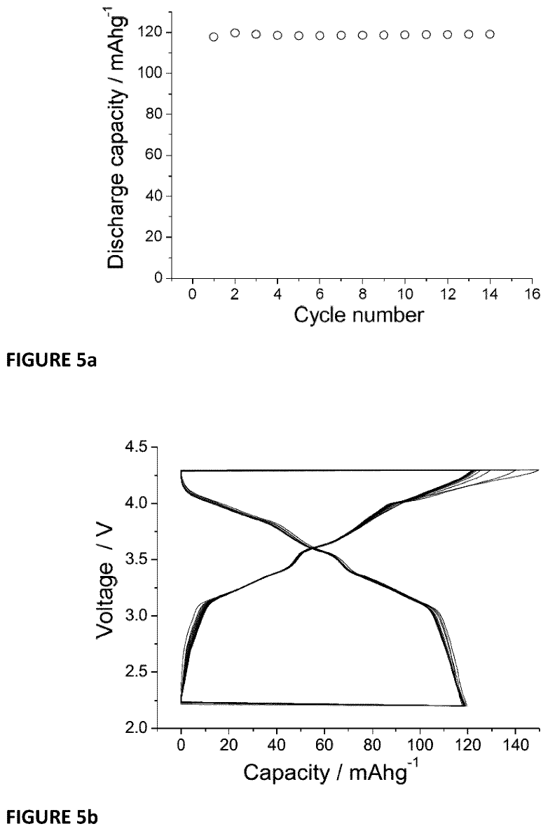

The resulting load curves of the materials of the second and third entries of Table 3 are shown in FIGS. 4b and 5b. The main regions correspond to the Ni²⁺/Ni³⁺ and Ni³⁺/Ni⁴⁺ redox couples, with a high voltage region (ca. >3.8 V) believed to result from reversible oxidation of O²⁻.

In each case, the initial charge capacity was significantly higher than the initial discharge capacity, confirming that the materials all contained sufficient Na for use in a full cell, and do not rely on additional Na from the metallic counter electrode to achieve high capacities in half cell format. The initial charge capacities for the materials shown in FIGS. 4 and 5 were 142 mAh g⁻¹ and 150 mAh g⁻¹ respectively.

As shown in FIGS. 4a and 5a, over subsequent cycles the materials of the invention (of the second and third entries of Table 3 showed very stable cycling behaviour with only very minor changes in the voltage profiles.

Summary of layered sodium metal oxide materials comprising zinc

A series of layered oxides based on the chemistry Na_{00.75}Mn_{0.68}Ni_{0.25}Zn_{0.07}O₂, with different P2:P3 ratios was synthesised using a citric acid sol-gel method and tested in electrochemical cells. When cycled between 2.2-4.3 V vs. Na⁺/Na at 25 mA g⁻¹, all materials showed excellent performance, with initial discharge capacities ranging from about 115 to 130 mAh g⁻¹, high average voltages (around 3.5V) and excellent capacity retention over at least 25 cycles (FIGS. 4 and 5).

### Layered Sodium Metal Oxide Materials Comprising Copper and Optionally Iron and Titanium

Materials comprising copper and optionally iron and titanium with different P2:P3 ratios were synthesised using the citric acid sol-gel method described above. The composition of the materials is detailed in Table 4.

TABLE 4
Chemical composition, calcination conditions and resultant phase composition
of the layered sodium metal oxide materials comprising copper

| | | Phase |
|---|---|---|
| | | composition |
| | | (P2:P3 ratio) |
| | | (where |
| Composition | Calcination Conditions | determined) |
| Na_{0.75}Mn_{0.68}Ni_{0.25}Cu_{0.07}O₂ | 780° C./3 hours, | 0.0:1.0 |
| | 500° C./5 hours | |
| | 800° C./3 hours, | 38.7:61.3 |
| | 500° C./5 hours | |
| | 820° C./3 hours, | 39.7:60.3 |
| | 500° C./5 hours | |
| | 840° C./3 hours, | 72.5:27.5 |
| | 500° C./5 hours | |
| | 840° C./20 hours, | 1.0:0.0 |
| | 500° C./5 hours | |
| Na_{0.75}Mn_{0.63}Ni_{0.25}Cu_{0.07}Ti_{0.05}O₂ | 700° C./3 hours, | 0.0:1.0 |
| | 500° C./5 hours | |
| | 760° C./3 hours, | 20.7:79.3 |
| | 500° C./5 hours | |
| | 780° C./3 hours, | 44.9:55.1 |
| | 500° C./5 hours | |
| | 800° C./3 hours, | 80.6:19.4 |
| | 500° C./5 hours | |
| | 840° C./3 hours, | 88.4:11.6 |
| | 500° C./5 hours | |
| | 900° C./10 hours, | 1.0:0.0 |
| | 500° C./5 hours | |
| | 960° C./12 hours, | 1.0:0.0 |
| | 500° C./5 hours | |
| Na_{0.75}Mn_{0.58} Ni_{0.25}Cu_{0.07}Ti_{0.1}O₂ | 700° C./3 hours, | |
| | 500° C./5 hours | |
| | 740° C./3 hours, | |
| | 500° C./5 hours | |
| | 800° C./3 hours, | 71.6:28.4 |
| | 500° C./5 hours | |
| | 800° C./3 hours, | |
| | 500° C./13 hours | |
| | 900° C./3 hours, | |
| | 500° C./5 hours | |
| Na_{0.75}Mn_{0.57}Ni_{0.25}Cu_{0.07}Fe_{0.1}O₂ | 800° C./3 hours, | 22.0:65.7:12.3(O3) |
| | 500° C./5 hours | |
| Na_{0.75}Mn_{0.52}Ni_{0.25}Cu_{0.07}Fe_{0.1}Ti_{0.05}O₂ | 840° C./1 hour, | |
| | 500° C./5 hours | |
| | 840° C./3 hours, | |
| | 500° C./5 hours | |
| | 860° C./3 hours, | 70.6:11.5:17.9(O3) |
| | 500° C./5 hours | |
| | 950° C./3 hours, | |
| | 500° C./5 hours | |
| | 1000° C./5 hours, | 1.0:0.0 |
| | 500° C./5 hours | |
| Na_{0.75}Mn_{0.52}Ni_{0.25}Cu_{0.07}Fe_{0.1}Ti_{0.05}O₂ | 840° C./3 hours in oxygen, | 53.8:5.5:40.7(O3) |
| | 500° C./5 hours | |
| | 1000° C./10 hours in | 1.0:0.0 |
| | oxygen, 500° C./5 hours | |
| Na_{0.85}Mn_{0.52}Ni_{0.25}Cu_{0.07}Fe_{0.1}Ti_{0.05}O₂ | 1000° C./10 hours in | O3 |
| | oxygen, 500° C./5 hours | |

### Material Characterisation

Powder x-ray diffraction (XRD) patterns were obtained using a Stoe STADIP diffractometer in Debye-Scherrer geometry with Mo Kα₁ radiation (λ=0.7093 Å). Structures were refined by the Rietveld method using GSAS.

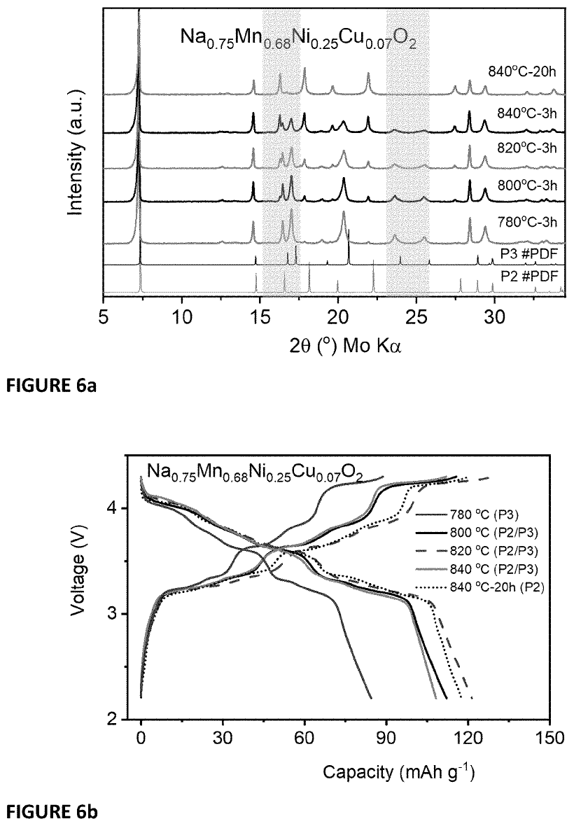

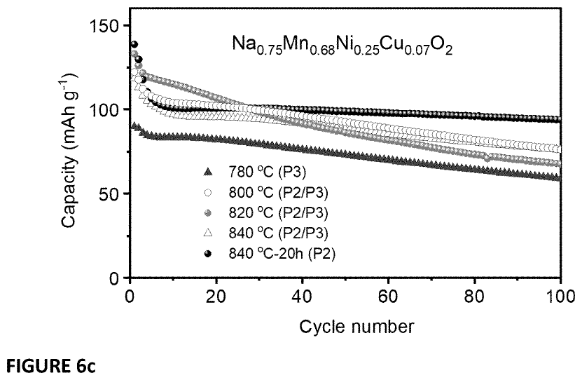

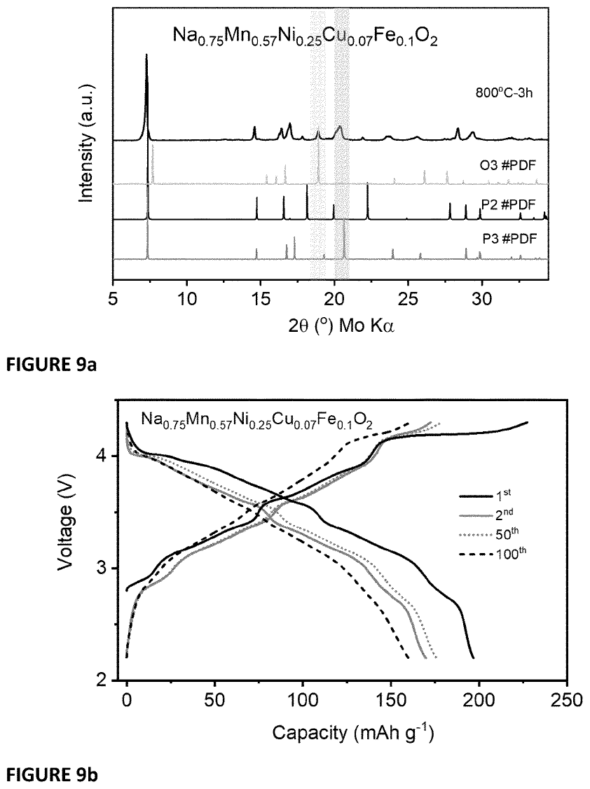

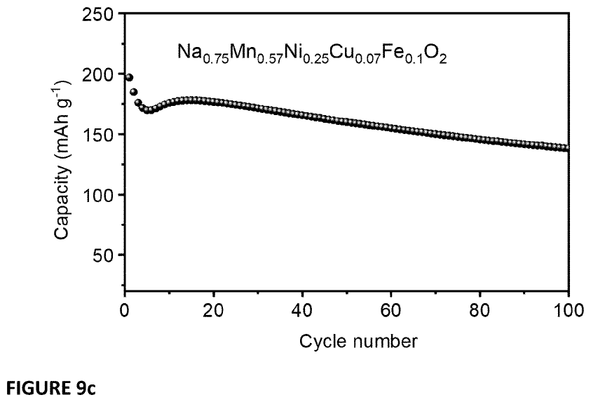

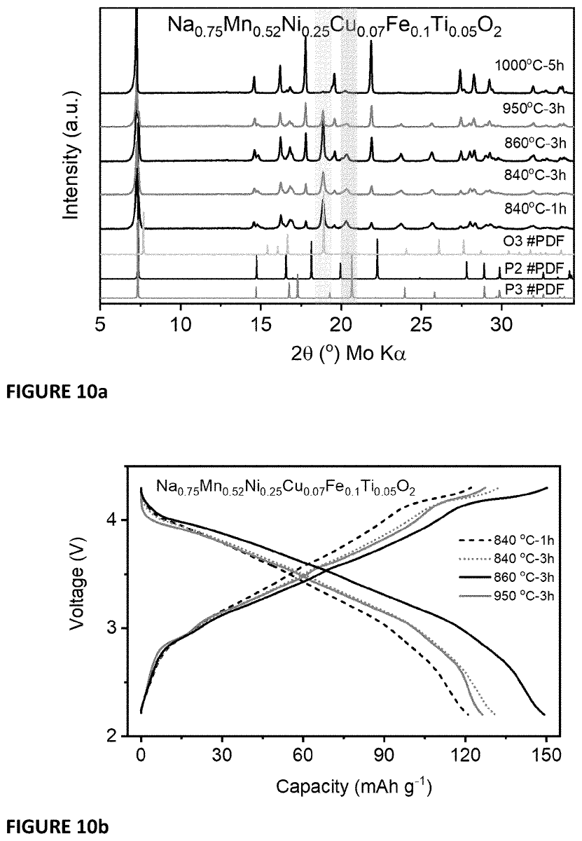

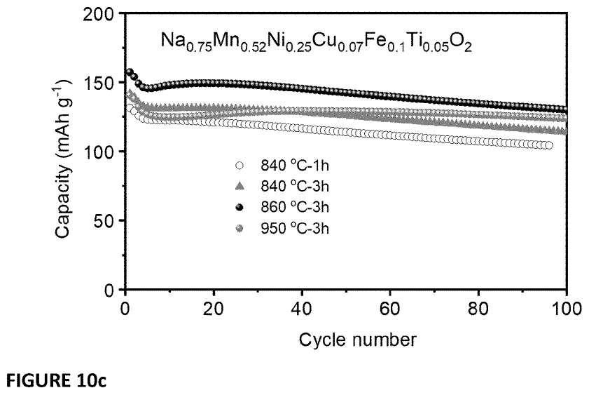

The results are shown in FIGS. 6a to 11a, showing the full range of diffraction peaks collected. The peaks for the respective phases are indicated in the figures.

### Electrochemical Characterisation

To investigate the electrochemical performance of the materials, slurries were prepared as described above. Galvanostatic charge/discharge cycling was carried out as described above.

The resulting load curves of the materials are shown in FIGS. 6b to 11b. The main regions correspond to the Ni²⁺/Ni³⁺ and Ni³⁺/Ni⁴⁺ redox couples, with a high voltage region (ca. >3.8 V) believed to result from reversible oxidation of Cu²⁺/Cu³⁺ and O²⁻.

In each case, the initial charge capacity was higher than the initial discharge capacity, confirming that the materials all contained sufficient Na for use in a full cell, and do not rely on additional Na from the metallic counter electrode to achieve high capacities in half cell format.

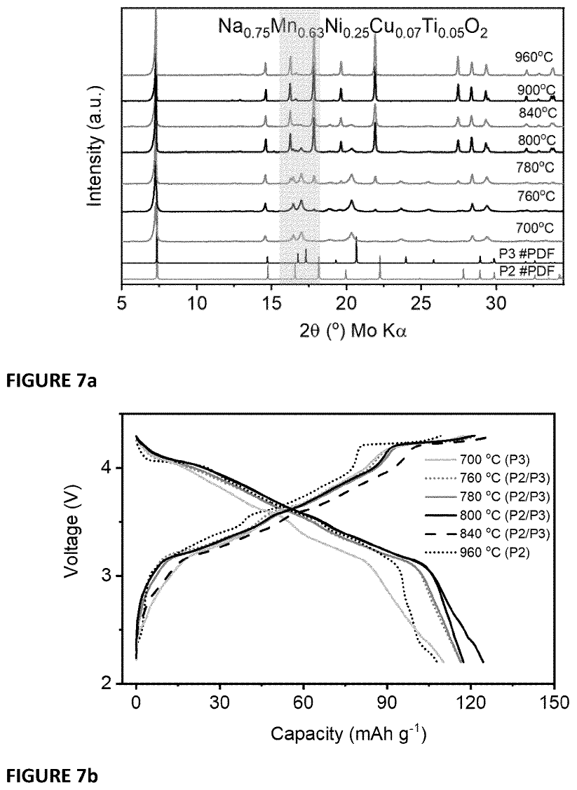

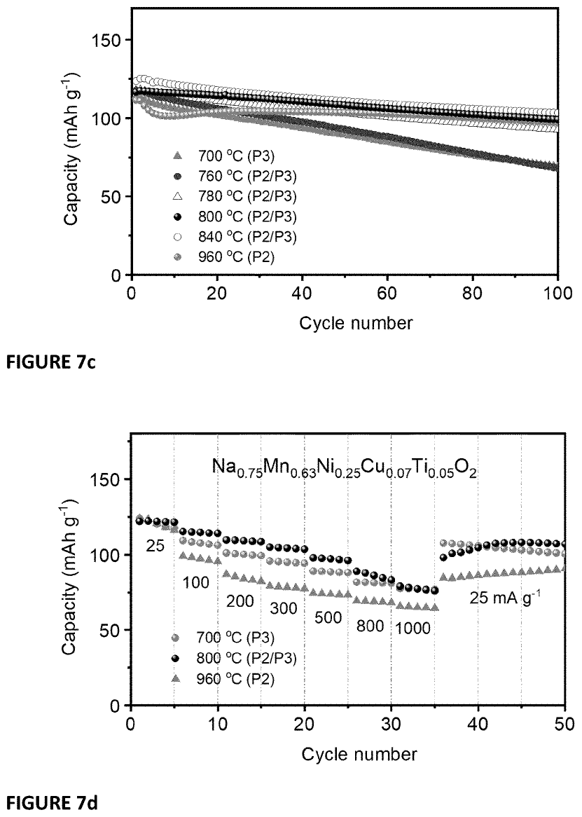

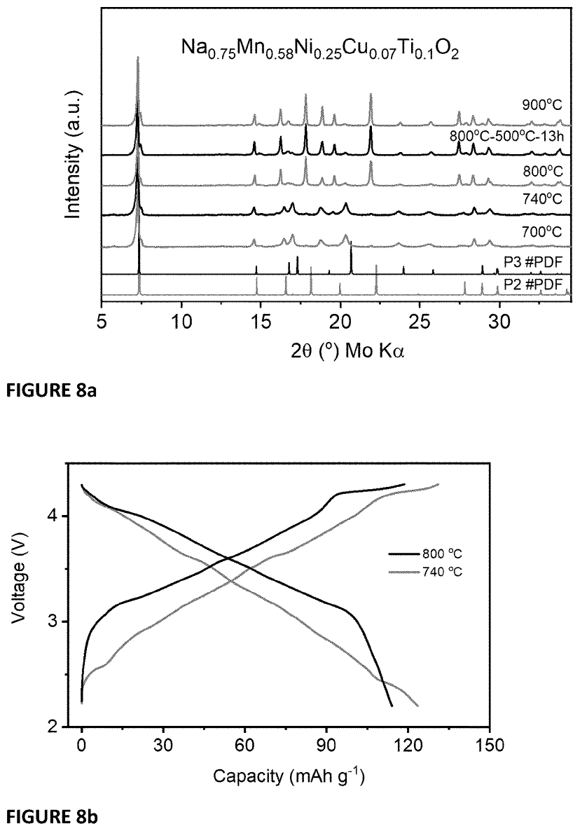

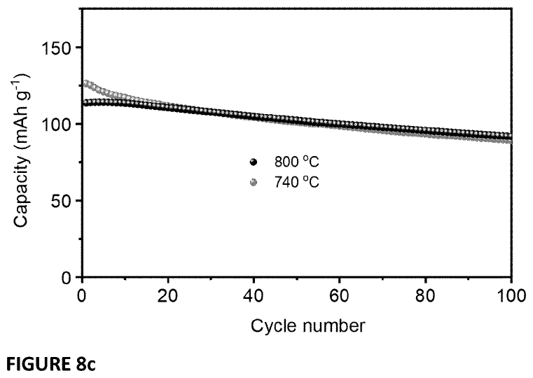

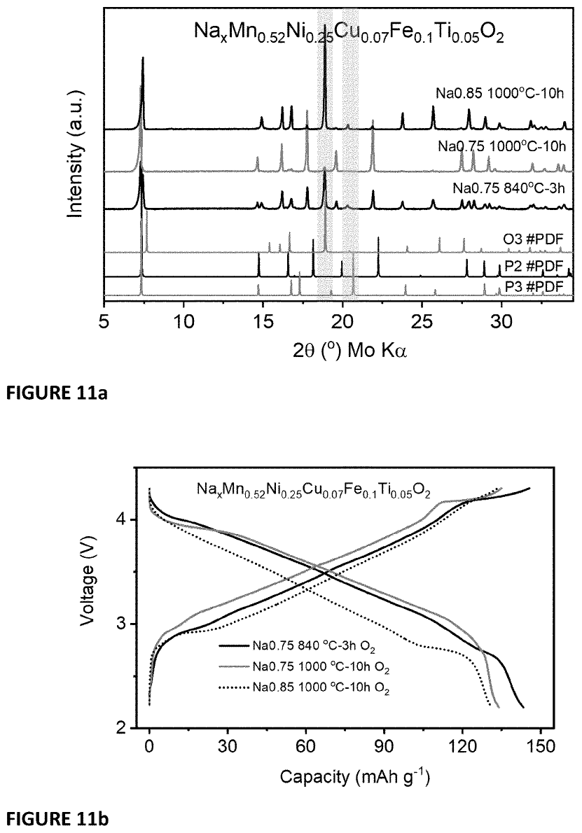

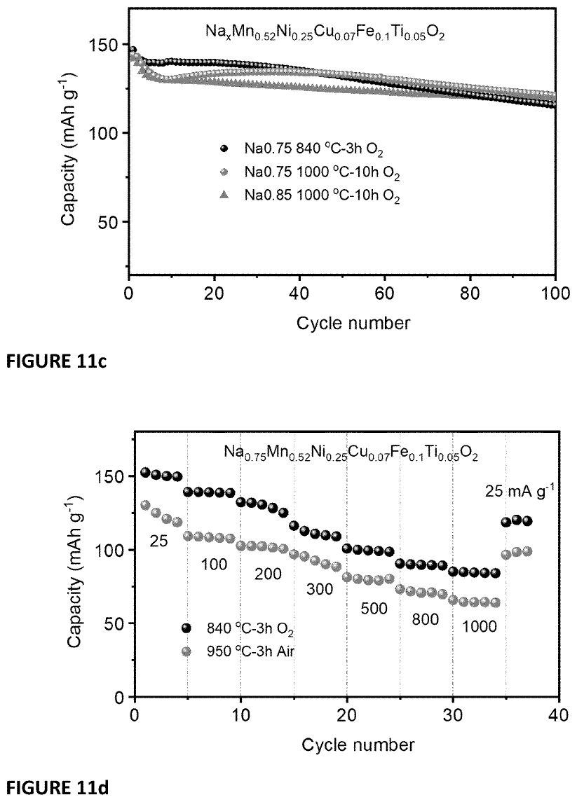

The cycling performances of the materials are compared in FIGS. 6c to 11c. All the materials were tested in a voltage range of 2.2-4.3 V vs. Na⁺/Na at 25 mA g⁻¹. Na_{0.75}Mn_{0.63}Ni_{0.25}Cu_{0.07}Ti_{0.05}O₂ and Na_{0.75}Mn_{0.58}Ni_{0.25}Cu_{0.07}Ti_{0.1}O₂ exhibit excellent cycling performance (capacity retention >80% over 100 cycles for P2/P3 materials), with initial discharge capacities ranging from about 113 to 126 mAh g⁻¹ (FIGS. 7c and 8c). Fe-containing materials showed a high initial discharge voltage of ˜3.6 V and good cycling stability. NaₓMn_{0.52}Ni_{0.25}Cu_{0.07}Fe_{0.1}Ti_{0.05}O₂ obtained in O₂ displayed an increased capacity retention (FIG. 11c).

As shown in FIGS. 7d and 11d, rate capability testing of Na_{0.75}Mn_{0.63}Ni_{0.25}Cu_{0.07}Ti_{0.05}O₂ (the second entry of Table 4) and Na_{0.85}Mn_{0.52}Ni_{0.25}Cu_{0.07}Fe_{0.1}Ti_{0.05}O₂ (the last entry of Table 4) revealed that the intergrowth of P2 and P3 phases can accelerate Na ion diffusion and improve their rate performance, and better crystalized materials obtained in O₂ with less O defects exhibit faster ion transport.

Electrodes comprising Na_{0.75}Mn_{0.63}Ni_{0.25}Cu_{0.07}Ti_{0.05}O₂ or Na_{0.75}Mn_{0.58}Ni_{0.25}Cu_{0.07}Ti_{0.1}O₂

Sodium metal oxide materials Na_{0.75}Mn_{0.63}Ni_{0.25}Cu_{0.07}Ti_{0.05}O₂ (obtained at 800° C.) and Na_{0.75}Mn_{0.58}Ni_{0.25}Cu_{0.07}Ti_{0.1}O₂ (obtained at 800° C.) were soaked in de-ionised (DI) water and placed in air for 10 days. The water-soaked materials were dried overnight in an oven at 80° C.

A mixture of sodium carboxymethyl cellulose (CMC) and styrene butadiene rubber (SBR) with a mass ratio of 7:3 dissolved in DI water was used as binder. The active cathode material super C65 as well as CMC/SBR binder were mixed into a homogeneous state in strict accordance with a mass specific gravity of 8:1:1 and uniformly coated on carbon-coated aluminum foil. The electrodes were dried at 80° C. for 12 h.

For water-soaked materials with PVdF binder, slurries were prepared using the dried water-soaked materials by the method above, super C65 carbon and PVdF, in the mass ratio 8:1:1, in NMP. The slurry was cast onto aluminum foil using a doctor blade in air. The electrodes were dried at 80° C. for 12 h.

### Material Characterisation

Powder x-ray diffraction (XRD) patterns were obtained using a Stoe STADIP diffractometer in Debye-Scherrer geometry with Mo Kα₁ radiation (λ=0.7093 Å). Structures were refined by the Rietveld method using GSAS.

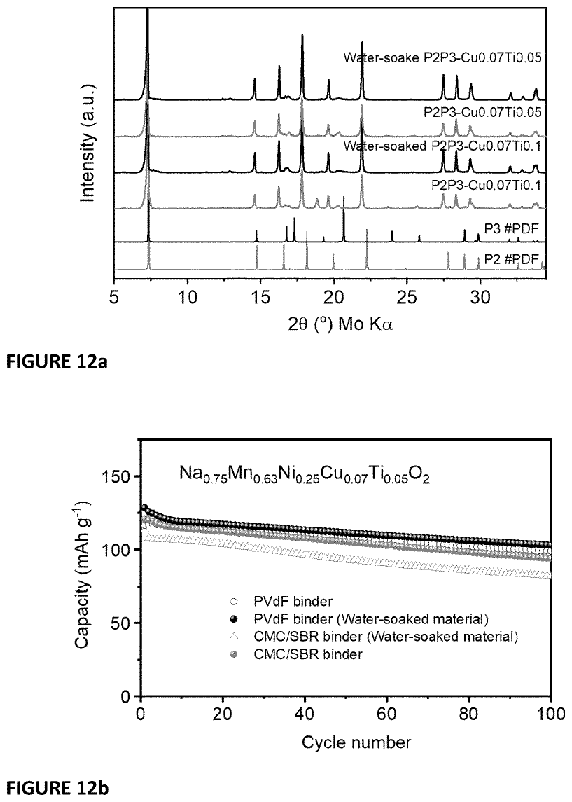

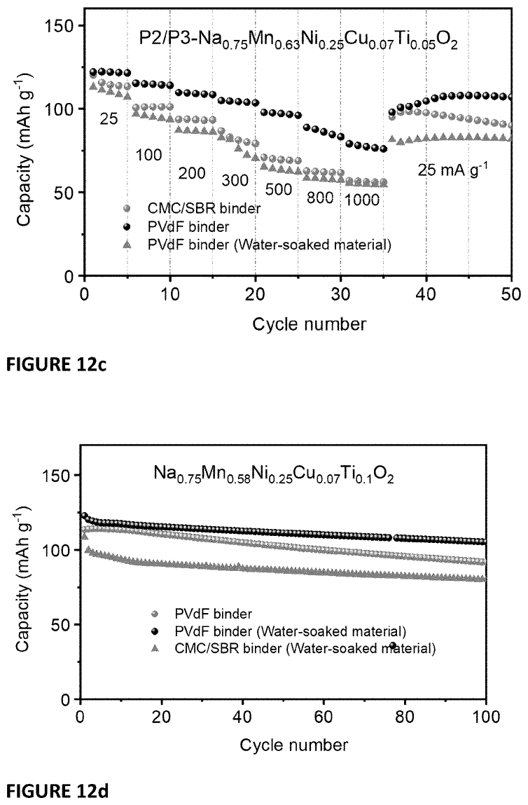

The results are shown in FIGS. 12a and 12d, showing the full range of diffraction peaks collected. The peaks for the respective phases are indicated in the figures.

### Electrochemical Characterisation

The cycling performances of the electrodes are compared in FIGS. 12b and 12d. Compared with pristine Na_{0.75}Mn_{0.63}Ni_{0.25}Cu_{0.07}Ti_{0.05}O₂ and Na_{0.75}Mn_{0.58}Ni_{0.25}Cu_{0.07}Ti_{0.1}O₂, the water-soaked materials show improved cycling stability with PVdF binder. Both of them exhibit excellent stability against water and air even using aqueous binders.

As shown in FIG. 12c, rate capability testing of electrodes comprising binders as well as water-soaked Na_{0.75}Mn_{0.63}Ni_{0.25}Cu_{0.07}Ti_{0.05}O₂ (obtained at 800° C.) revealed that PVdF binder is better for Na ion diffusion and delivering higher rate performance, but all electrode formulation exhibit good performance.

Summary of layered sodium metal oxide materials comprising copper, titanium and iron

A series of layered oxides based on the chemistry Na_{0.75}Mn_{0.63}Ni_{0.25}Cu_{0.07}Ti_{0.05}O₂, Na_{0.75}Mn_{0.58}Ni_{0.25}Cu_{0.07}Ti_{0.1}O₂, and NaₓMn_{0.52}Ni_{0.25}Cu_{0.07}Fe_{0.1}Ti_{0.05}O₂ with different P2:P3 ratios was synthesised using a citric acid sol-gel method and tested in electrochemical cells. All materials showed excellent performance with excellent cycling stability and rate capability. Of note, Cu and Ti doping can effectively improve water and air stability of P2/P3 materials.

Layered sodium metal oxide materials comprising zinc and either magnesium, titanium or iron

Materials comprising zinc and either magnesium, titanium or iron with different P2:P3 ratios were synthesised using the citric acid sol-gel method described above. The composition of the materials is detailed in Table 5.

TABLE 5
Chemical composition, calcination conditions and resultant
phase composition of the layered sodium metal oxide materials
comprising zinc and either magnesium, titanium or iron

| | | Phase |
|---|---|---|
| | | composition |
| Composition | Calcination Conditions | (P2:P3 ratio) |
| Na_{0.75}Mn_{0.65}Ni_{0.25}Mg_{0.05}Zn_{0.05}O₂ | 860° C./3 hours, | 68.1:31.9 |
| | 500° C./5 hours | |
| Na_{0.75}Mn_{0.58}Ni_{0.27} Ti_{0.1}Zn_{0.07}O₂ | 820° C./3 hours, | 74.2:25.8 |
| | 500° C./5 hours | |
| Na_{0.75}Mn_{0.65}Ni_{0.25}Fe_{0.05}Zn_{0.05}O₂ | 850° C./3 hours, | 65.7:34.3 |
| | 500° C./5 hours | |

### Material Characterisation

Powder x-ray diffraction (XRD) patterns were obtained using a Stoe STADIP diffractometer in Debye-Scherrer geometry with Mo Kα₁ radiation (λ=0.7093 Å). Structures were refined by the Rietveld method using Topas Academic.

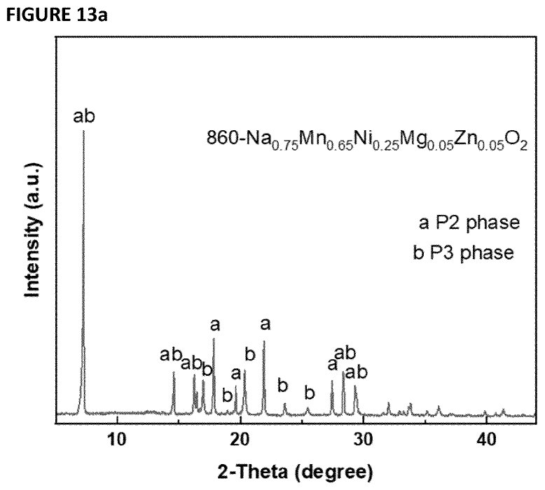

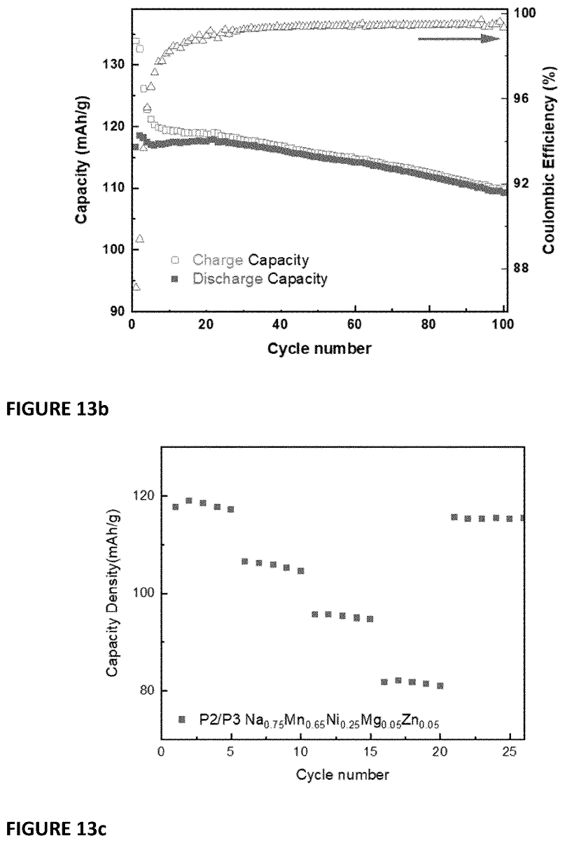

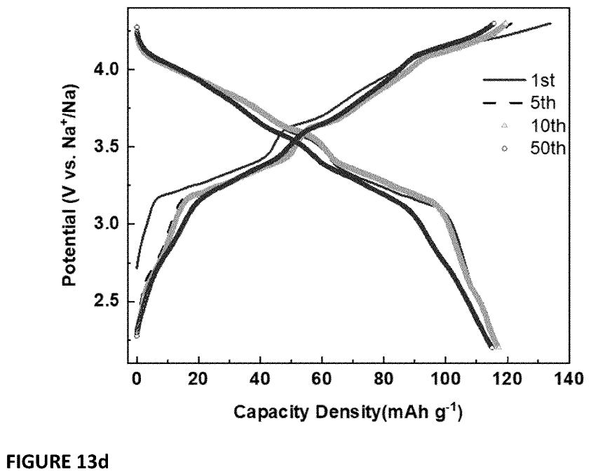

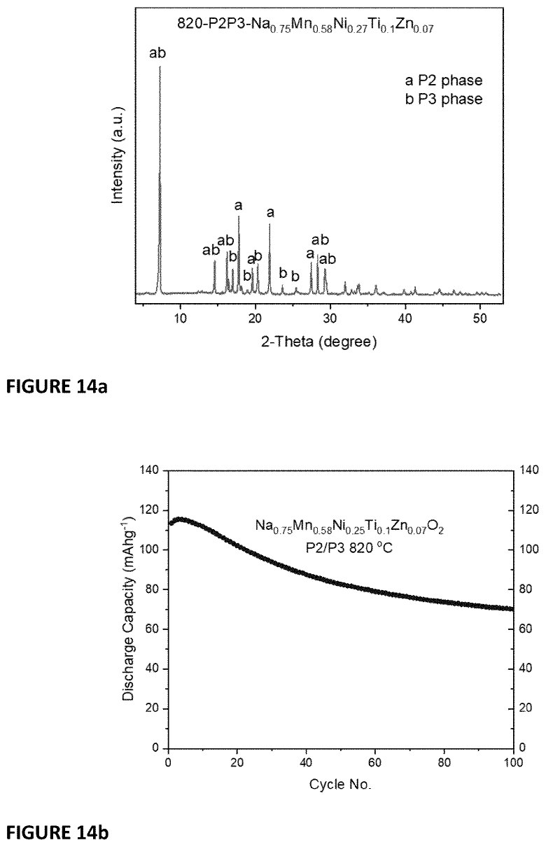

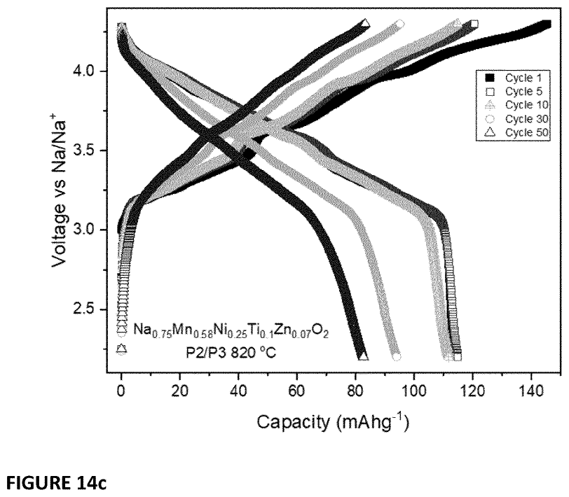

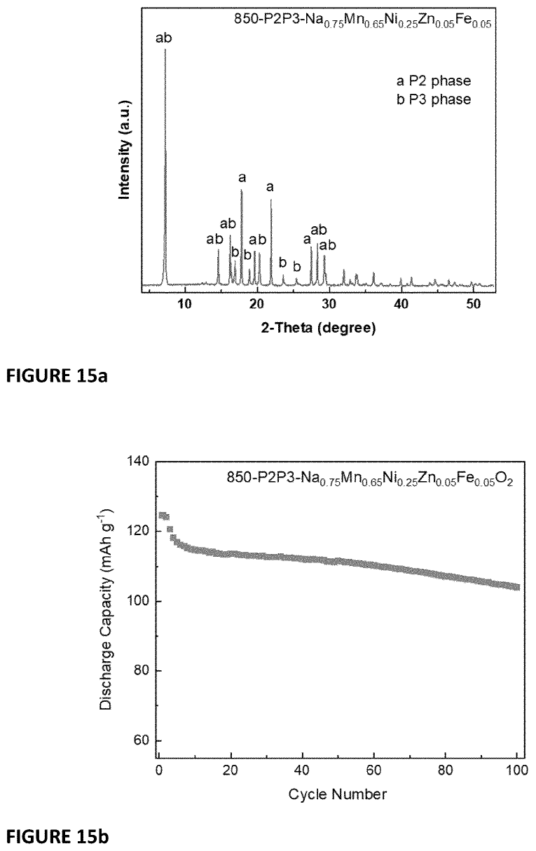

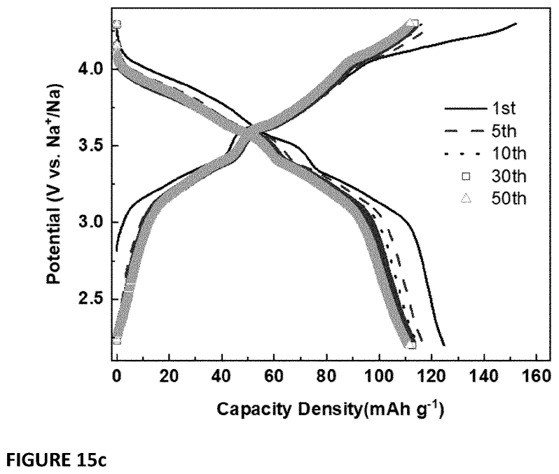

The results are shown in FIGS. 13a, 14a and 15a, showing the full range of diffraction peaks collected. The peaks for the respective phases are indicated in the figures.

### Electrochemical Characterisation

To investigate the electrochemical performance of the materials, slurries were prepared as described above. Galvanostatic charge/discharge cycling was carried out as described above.

The resulting load curves of the materials are shown in FIGS. 13d, 14c and 15c. The main regions correspond to the Ni²⁺/Ni³⁺ and Ni³⁺/Ni⁴⁺ redox couples, with a high voltage region (ca. >3.8 V) believed to result from reversible oxidation of O²⁻.

In each case, the initial charge capacity was higher than the initial discharge capacity, confirming that the materials all contained sufficient Na for use in a full cell, and do not rely on additional Na from the metallic counter electrode to achieve high capacities in half cell format.

The cycling performances of the materials are compared in FIGS. 13b, 14b and 15b. All show high capacities with good or very good cycling stability. Particularly good performance was obtained from Na_{0.75}Mn_{0.65}Ni_{0.25}Mg_{0.05}Zn_{0.05}O₂ which showed both highest capacity and best capacity retention (110 mAhg⁻¹ after 100 cycles). Na_{0.75}Mn_{0.65}Ni_{0.25}Fe_{0.05}Zn_{0.05}O₂ also showed promising behaviour.

As shown in FIG. 13c, rate capability testing of Na_{0.75}Mn_{0.65}Ni_{0.25}Mg_{0.05}Zn_{0.05}O₂ (the first entry of Table 5) revealed that it demonstrates particularly good performance at high rates (>80 mAhg⁻¹ at 500 mAg⁻¹) and the initial capacity is restored on returning to the initial cycling rate, indicating good stability. . . .

Summary of layered sodium metal oxide materials comprising zinc and either magnesium, titanium or iron. A series of materials with different P2/P3 ratios containing Zn and one out of Mg, Ti and Fe was prepared via a sol-gel route. These all displayed promising electrochemical properties particularly Na_{0.75}Mn_{0.65}Ni_{0.25}Mg_{0.05}Zn_{0.05}O₂ in which Zn and Mg were used. This material showed high capacity, good capacity retention and good rate capability.

### Additional Layered Sodium Metal Oxide Material Comprising Iron

An additional material comprising iron was synthesised using the citric acid sol-gel method described above. The composition of the material is detailed in Table 6.

TABLE 6
Chemical composition, calcination conditions and
resultant phase composition of the additional layered
sodium metal oxide material comprising iron

| | | Phase |
|---|---|---|
| | | composition |
| Composition | Calcination Conditions | (P2:P3 ratio) |
| Na_{0.75}Mn_{0.65}Ni_{0.25}Fe_{0.1}O₂ | 820° C./3 hours, | 70.2:29:8 |
| | 500° C./5 hours | |

Powder x-ray diffraction (XRD) patterns were obtained using a Stoe STADIP diffractometer in Debye-Scherrer geometry with Mo Kα₁ radiation (λ=0.7093 Å). Structures were refined by the Rietveld method using Topas Academic.

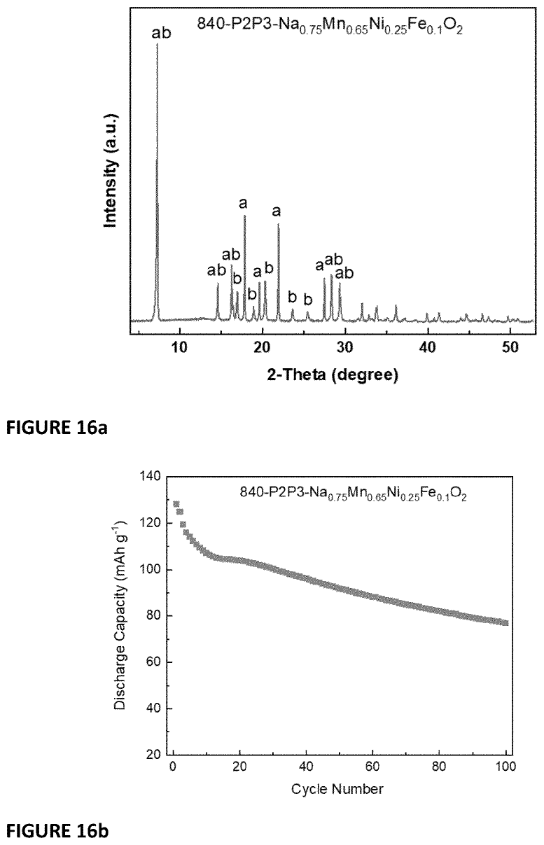

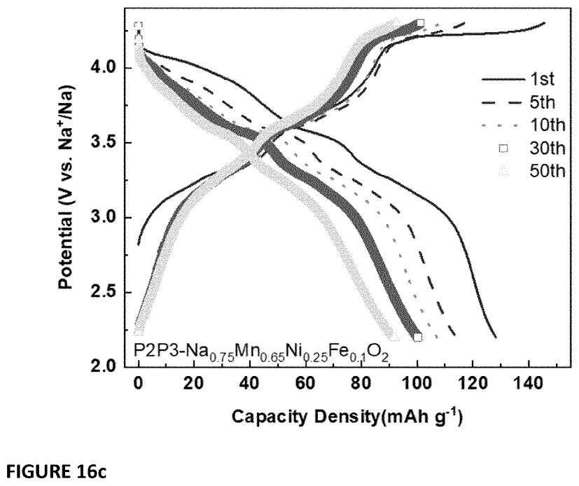

The results are shown in FIG. 16a, which shows the full range of diffraction peaks collected. The peaks labelled “a” correspond to the P2 phase and the peaks labelled “b” correspond to the P3 phase.

### Electrochemical Characterisation

To investigate the electrochemical performance of the materials, slurries were prepared as described above. Galvanostatic charge/discharge cycling was carried out as described above.

The load curve of the material is shown in FIG. 16c. The main regions correspond to the Ni²⁺/Ni³⁺ and Ni³⁺/Ni⁴⁺ redox couples, together with the Fe³⁺/Fe⁴⁺ couple with a high voltage region (ca. >3.8 V) believed to result from reversible oxidation of O²⁻.

In each case, the initial charge capacity was higher than the initial discharge capacity, confirming that the material contained sufficient Na for use in a full cell, and does not rely on additional Na from the metallic counter electrode to achieve high capacities in half cell format.

The cycling performances of the material is shown in FIGS. 16b and 16c and demonstrate high discharge voltage with moderate capacity fade.

Summary of additional layered sodium metal oxide material comprising iron. A layered oxide based on the chemistry NaₓMn_{0.65}Ni_{0.25}Fe_{0.1}O₂ containing a composite of P2 and P3 phases was synthesised using a citric acid sol-gel method and tested in electrochemical cells. The material showed reasonable cycling stability.

1. A layered sodium metal oxide material having at least a P2-type phase and a P3-type phase, the material having the general formula: 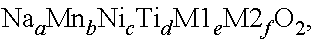
wherein:
M1 is an element selected from iron, copper, zinc, and aluminium; M2 consists of one or more elements different to M1 and selected from iron, copper, zinc, magnesium and aluminium; and
wherein:
$$0.5 < a \leq 1 ;$$
$$0 \leq b \leq 0.7 ;$$
$$0 < c \leq 0.5 ;$$
$$0 \leq d \leq 0.4 ;$$
$$0 < e \leq 0.25 ;$$
$$0 < e + f \leq 0.25 ; and$$
$$b + c + d + e + f \leq 1 .$$

2. The material of claim 1, wherein:
$$0.6 \leq a \leq 0.9 ; and / or$$
$$0.2 \leq b \leq 0.7 ; and / or$$
$$0.2 \leq c \leq 0.5 .$$

3. The material of claim 1, wherein:
$$0.6 \leq a \leq 0.9$$
$$b + d \leq 0.7 ;$$
$$0.25 \leq c \leq 0.4 ; and / or$$
$$0 < e + f \leq 0.2 .$$

4. The material of claim 1, wherein d+f>0.

5. The material of claim 1, wherein f>0.

6. The material of claim 1, wherein d>0.

7. The material of claim 1, wherein M1 is an element selected from iron, copper and zinc.

8. The material of claim 1, wherein M2 consists of one or more elements different to M1 and selected from iron, copper, zinc, and magnesium.

9. The material of claim 1, wherein M1 is copper and M2 is iron.

10. The material of claim 1, wherein the material comprises 0.1 to 99.9 wt % of the P2-type phase and 99.9 to 0.1 wt % of the P3-type phase.

11. An electrode comprising the material of claim 1.

12. An energy storage device comprising the material of claim 1, optionally wherein the energy storage device is a sodium-ion battery.

13. A method of forming material as defined in claim 1, the method comprising:
(a) providing a metal salt solution, the metal salts including salts of Na, Mn, Ni, and M1;
(b1) optionally mixing a Ti source with the metal salt solution;
(b2) optionally mixing a salt of M2 with the metal salt solution;
(c) mixing a gelator with the metal salt solution to form a sol-gel solution;
(d) heating the sol-gel solution to form a gel; and
(e) subjecting the gel to calcination to obtain the material;
wherein M1 is an element selected from iron, copper, zinc, and aluminium; and M2 consists of one or more elements different to M1 and selected from iron, copper, zinc, magnesium and aluminium.

14. The method of claim 13, wherein the gelator is a carboxylic acid, optionally wherein the carboxylic acid is citric acid.

15. The method of claim 13, wherein the stoichiometric ratio of gelator to metal salts is 1:1.

16. The method of claim 13, wherein step (d) includes heating the sol-gel solution to a temperature from 60 to 100° C., optionally wherein step (d) includes heating the sol-gel solution for 2 to 24 hours.

17. The method of claim 13, wherein step (d) includes drying the gel formed at temperatures of 100 to 150° C.

18. The method of claim 13, wherein step (e) includes subjecting the gel to calcination in an oxidising atmosphere, optionally wherein the oxidising atmosphere is air or oxygen.

19. The method of claim 13, wherein step (e) includes:
(f) calcining the gel at a first temperature of 400 to 800° C., then
(g) calcining the gel one or more times at a second temperature of 600 to 1000° C., and then
(h) calcining the gel at a third temperature of 400 to 600° C.

20. The method of claim 19, wherein step (f) includes calcining the gel at the first temperature for 2 to 6 hours and step (g) includes calcining the gel one or more times at the second temperature for 0.5 to 20 hours.
